(19) United States
(12) Patent Application Publication
(10) Pub. No.: US 2025/0007586 A1
(43) Pub. Date: Jan. 2, 2025

(54) TEMPORAL AND SPATIAL PRECODING OF DOWNLINK SIGNALS

(71) Applicant: QUALCOMM INCORPORATED, San Diego, CA (US)

(72) Inventors: Wei Xi, Beijing (CN); Liangming Wu, Beijing (CN); Yu Zhang, San Diego, CA (US); Chenxi Hao, Beijing (CN); Min Huang, Beijing (CN); Jing Dai, Beijing (CN); Chao Wei, Beijing (CN); Rui Hu, Beijing (CN); Hao Xu, Beijing (CN)

(21) Appl. No.: 18/709,470

(22) PCT Filed: Jan. 27, 2022
(86) PCT No.: PCT/CN2022/074226

§ 371 Date: May 10, 2024

(51) Int. Cl. H04B 7/06; H04B 7/01

(52) U.S. Cl. CPC H04B 7/0626; H04B 7/01; H04B 7/0667

(57) ABSTRACT

Methods, systems, and devices for wireless communication are described to support reducing a time domain selectivity of a downlink channel with multiple signal paths. A base station may spatially precode multiple channel state information reference signals (CSI-RSs) and transmit the spatially precoded CSI-RSs to a user equipment (UE), where at least one spatially precoded CSI-RS may correspond to each signal path. Based on the spatially precoded CSI-RSs, the UE may determine a mean or average Doppler shift for each signal path. The UE may transmit, to the base station, signaling indicative of the respective average Doppler shifts for each signal path. Based on the indication of the Doppler shifts, the base station may spatially and temporally precode one or more downlink transmissions to the UE, which may reduce the time domain selectivity of the downlink channel.

### CROSS REFERENCE

The present Application is a 371 national stage filing of International PCT Application No. PCT/CN2022/074226 by XI et al. entitled “TEMPORAL AND SPATIAL PRECODING OF DOWNLINK SIGNALS,” filed Jan. 27, 2022, which is assigned to the assignee hereof, and which is expressly incorporated by reference in its entirety herein.

### FIELD OF TECHNOLOGY

The following relates to wireless communication, including temporal and spatial precoding of downlink signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). In some cases, if a UE is moving, the UE may experience a Doppler shift in a signal (e.g., a downlink signal, an uplink signal) communicated with the UE (e.g., received by the UE, transmitted from the UE).

### SUMMARY

The described techniques relate to improved methods, systems, devices, and apparatuses that support temporal and spatial precoding of downlink signals. Generally, the described techniques provide for reducing a time domain selectivity of downlink transmissions communicated via one or more signal paths (e.g., multiple signal paths). For example, a base station may spatially precode multiple channel state information reference signals (CSI-RSs) and transmit the spatially precoded CSI-RSs to a user equipment (UE), where at least one spatially precoded CSI-RS may correspond to each signal path. Based on the spatially precoded CSI-RSs, the UE may determine a parameter associated with a Doppler shift, such as a mean or average Doppler shift (e.g., an averaged Doppler shift), for each signal path. The UE may transmit, to the base station, signaling indicative of the respective parameter associated with the Doppler shift, such as the average Doppler shift for each signal path. Based on the indication of the parameter, such as the Doppler shifts, the base station may spatially and temporally precode one or more downlink transmissions to the UE, which may reduce the time domain selectivity of the one or more downlink transmissions, among other advantages.

A method for wireless communication at a user equipment (UE) is described. The method may include receiving, from a base station, a first CSI-RS via a first signal path and a second CSI-RS via a second signal path, where the first CSI-RS and the second CSI-RS are each spatially precoded based on a prior communication with the base station, transmitting, to the base station and based on receiving the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, and receiving, from the base station, a downlink signal communicated via the first signal path using first temporal and spatial precoding and communicated via the second signal path using second temporal and spatial precoding, the first temporal and spatial precoding and the second temporal and spatial precoding based on the indication of the first Doppler frequency shift and the second Doppler frequency shift.

An apparatus for wireless communication at a UE is described. The apparatus may include a processor, memory coupled with the processor, and instructions stored in the memory. The instructions may be executable by the processor to cause the apparatus to receive, from a base station, a first CSI-RS via a first signal path and a second CSI-RS via a second signal path, where the first CSI-RS and the second CSI-RS are each spatially precoded based on a prior communication with the base station, transmit, to the base station and based on receiving the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, and receive, from the base station, a downlink signal communicated via the first signal path using first temporal and spatial precoding and communicated via the second signal path using second temporal and spatial precoding, the first temporal and spatial precoding and the second temporal and spatial precoding based on the indication of the first Doppler frequency shift and the second Doppler frequency shift.

Another apparatus for wireless communication at a UE is described. The apparatus may include means for receiving, from a base station, a first CSI-RS via a first signal path and a second CSI-RS via a second signal path, where the first CSI-RS and the second CSI-RS are each spatially precoded based on a prior communication with the base station, means for transmitting, to the base station and based on receiving the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, and means for receiving, from the base station, a downlink signal communicated via the first signal path using first temporal and spatial precoding and communicated via the second signal path using second temporal and spatial precoding, the first temporal and spatial precoding and the second temporal and spatial precoding based on the indication of the first Doppler frequency shift and the second Doppler frequency shift.

A non-transitory computer-readable medium storing code for wireless communication at a UE is described. The code may include instructions executable by a processor to receive, from a base station, a first CSI-RS via a first signal path and a second CSI-RS via a second signal path, where the first CSI-RS and the second CSI-RS are each spatially precoded based on a prior communication with the base station, transmit, to the base station and based on receiving the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, and receive, from the base station, a downlink signal communicated via the first signal path using first temporal and spatial precoding and communicated via the second signal path using second temporal and spatial precoding, the first temporal and spatial precoding and the second temporal and spatial precoding based on the indication of the first Doppler frequency shift and the second Doppler frequency shift.

Some examples of the method, apparatuses, and non-transitory computer-readable medium described herein may further include operations, features, means, or instructions for determining the first Doppler frequency shift based on receiving the first CSI-RS, where the signaling indicative of the first Doppler frequency shift includes an indication of the determined first Doppler frequency shift and determining the second Doppler frequency shift based on receiving the second CSI-RS, where the signaling indicative of the second Doppler frequency shift includes an indication of the determined second Doppler frequency shift.

In some examples of the method, apparatuses, and non-transitory computer-readable medium described herein, the first Doppler frequency shift includes the average of the first set of multiple Doppler frequency shifts divided by a Doppler frequency shift and the second Doppler frequency shift includes the average of the second set of multiple Doppler frequency shifts divided by the Doppler frequency shift.

In some examples of the method, apparatuses, and non-transitory computer-readable medium described herein, the first CSI-RS corresponds to a first CSI-RS port, the second CSI-RS corresponds to a second CSI-RS port, and the first CSI-RS port and the second CSI-RS port correspond to a same CSI-RS port group or CSI-RS resource.

In some examples of the method, apparatuses, and non-transitory computer-readable medium described herein, the first CSI-RS corresponds to a first CSI-RS resource, the second CSI-RS corresponds to a second CSI-RS resource, and the first CSI-RS resource and the second CSI-RS resource correspond to a same CSI-RS resource set.

In some examples of the method, apparatuses, and non-transitory computer-readable medium described herein, the first CSI-RS and the second CSI-RS may be each temporally precoded and the method, apparatuses, and non-transitory computer-readable medium may include further operations, features, means, or instructions for receiving, via the first signal path, one or more third CSI-RSs that may be spatially and temporally precoded, receiving, via the second signal path, one or more fourth CSI-RSs that may be spatially and temporally precoded, selecting a CSI-RS having a lowest average Doppler frequency shift from a first set of CSI-RSs that includes the first CSI-RS and the one or more third CSI-RSs, where the signaling indicative of the first Doppler frequency shift includes an indication of the CSI-RS selected from the first set of CSI-RSs, and where the first Doppler frequency shift includes the lowest average Doppler frequency shift associated with the first set of CSI-RSs, and selecting a CSI-RS having a lowest average Doppler frequency shift from a second set of CSI-RSs that includes the second CSI-RS and the one or more fourth CSI-RSs, where the signaling indicative of the second Doppler frequency shift includes an indication of the CSI-RS selected from the second set of CSI-RSs, and where the second Doppler frequency shift includes the lowest average Doppler frequency shift associated with the second set of CSI-RSs.

In some examples of the method, apparatuses, and non-transitory computer-readable medium described herein, each CSI-RS of the first set of CSI-RSs may be spatially precoded using a first spatial precoding, each CSI-RS of the second set of CSI-RSs may be spatially precoded using a second spatial precoding, each CSI-RS of the first set of CSI-RSs may be temporally precoded using different temporal precoding, and each CSI-RS of the second set of CSI-RSs may be temporally precoded using different temporal precoding.

In some examples of the method, apparatuses, and non-transitory computer-readable medium described herein, the first CSI-RS corresponds to a first CSI-RS port, the one or more third CSI-RSs each correspond to a respective third CSI-RS port, the first CSI-RS port and the one or more third CSI-RS ports correspond to a first CSI-RS port group or a first CSI-RS resource, the second CSI-RS corresponds to a second CSI-RS port, the one or more fourth CSI-RSs each correspond to a respective fourth CSI-RS port, and the second CSI-RS port and the one or more fourth CSI-RS ports correspond to a second CSI-RS port group or a second CSI-RS resource.

In some examples of the method, apparatuses, and non-transitory computer-readable medium described herein, the first CSI-RS corresponds to a first CSI-RS resource, the one or more third CSI-RSs each correspond to a respective third CSI-RS resource, the first CSI-RS resource and the one or more third CSI-RS resources correspond to a first CSI-RS resource set, the second CSI-RS corresponds to a second CSI-RS resource, the one or more fourth CSI-RSs each correspond to a respective fourth CSI-RS resource, and the second CSI-RS resource and the one or more fourth CSI-RS resources correspond to a second CSI-RS resource set.

Some examples of the method, apparatuses, and non-transitory computer-readable medium described herein may further include operations, features, means, or instructions for determining a first temporal parameter for a first precoder associated with the first CSI-RS based on the first Doppler frequency shift for the first CSI-RS, where the signaling indicative of the first Doppler frequency shift includes an indication of the first temporal parameter for the first precoder and determining a second temporal parameter for a second precoder associated with the second CSI-RS based on the second Doppler frequency shift for the second CSI-RS, where the signaling indicative of the second Doppler frequency shift includes an indication of the second temporal parameter for the second precoder.

In some examples of the method, apparatuses, and non-transitory computer-readable medium described herein, the first temporal and spatial precoding for the downlink signal uses the first precoder and the first temporal parameter and the second temporal and spatial precoding for the downlink signal uses the second precoder and the second temporal parameter.

In some examples of the method, apparatuses, and non-transitory computer-readable medium described herein, the downlink signal includes a CSI-RS, a demodulation reference signal, a downlink control channel, a downlink shared channel, or any combination thereof.

A method for wireless communication at a base station is described. The method may include transmitting, to a UE, a first CSI-RS via a first signal path and a second CSI-RS via a second signal path, where the first CSI-RS and the second CSI-RS are each spatially precoded based on a prior communication with the UE, receiving, from the UE and based on transmitting the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, and transmitting, to the UE, a downlink signal communicated via the first signal path using first temporal and spatial precoding and communicated via the second signal path using second temporal and spatial precoding, the first temporal and spatial precoding and the second temporal and spatial precoding determined based on the indication of the first Doppler frequency shift and the second Doppler frequency shift.

An apparatus for wireless communication at a base station is described. The apparatus may include a processor, memory coupled with the processor, and instructions stored in the memory. The instructions may be executable by the processor to cause the apparatus to transmit, to a UE, a first CSI-RS via a first signal path and a second CSI-RS via a second signal path, where the first CSI-RS and the second CSI-RS are each spatially precoded based on a prior communication with the UE, receive, from the UE and based on transmitting the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, and transmit, to the UE, a downlink signal communicated via the first signal path using first temporal and spatial precoding and communicated via the second signal path using second temporal and spatial precoding, the first temporal and spatial precoding and the second temporal and spatial precoding determined based on the indication of the first Doppler frequency shift and the second Doppler frequency shift.

Another apparatus for wireless communication at a base station is described. The apparatus may include means for transmitting, to a UE, a first CSI-RS via a first signal path and a second CSI-RS via a second signal path, where the first CSI-RS and the second CSI-RS are each spatially precoded based on a prior communication with the UE, means for receiving, from the UE and based on transmitting the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, and means for transmitting, to the UE, a downlink signal communicated via the first signal path using first temporal and spatial precoding and communicated via the second signal path using second temporal and spatial precoding, the first temporal and spatial precoding and the second temporal and spatial precoding determined based on the indication of the first Doppler frequency shift and the second Doppler frequency shift.

A non-transitory computer-readable medium storing code for wireless communication at a base station is described. The code may include instructions executable by a processor to transmit, to a UE, a first CSI-RS via a first signal path and a second CSI-RS via a second signal path, where the first CSI-RS and the second CSI-RS are each spatially precoded based on a prior communication with the UE, receive, from the UE and based on transmitting the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, and transmit, to the UE, a downlink signal communicated via the first signal path using first temporal and spatial precoding and communicated via the second signal path using second temporal and spatial precoding, the first temporal and spatial precoding and the second temporal and spatial precoding determined based on the indication of the first Doppler frequency shift and the second Doppler frequency shift.

In some examples of the method, apparatuses, and non-transitory computer-readable medium described herein, receiving the signaling indicative of the first Doppler frequency shift and the second Doppler frequency shift may include operations, features, means, or instructions for receiving an indication of the first Doppler frequency shift determined by the UE and an indication of the second Doppler frequency shift determined by the UE.

In some examples of the method, apparatuses, and non-transitory computer-readable medium described herein, the first Doppler frequency shift includes the average of the first set of multiple Doppler frequency shifts divided by a Doppler frequency shift and the second Doppler frequency shift includes the average of the second set of multiple Doppler frequency shifts divided by the Doppler frequency shift.

In some examples of the method, apparatuses, and non-transitory computer-readable medium described herein, the first CSI-RS corresponds to a first CSI-RS port, the second CSI-RS corresponds to a second CSI-RS port, and the first CSI-RS port and the second CSI-RS port correspond to a same CSI-RS port group or CSI-RS resource.

In some examples of the method, apparatuses, and non-transitory computer-readable medium described herein, the first CSI-RS corresponds to a first CSI-RS resource, the second CSI-RS corresponds to a second CSI-RS resource, and the first CSI-RS resource and the second CSI-RS resource correspond to a same CSI-RS resource set.

In some examples of the method, apparatuses, and non-transitory computer-readable medium described herein, the first CSI-RS and the second CSI-RS may be each temporally precoded and the method, apparatuses, and non-transitory computer-readable medium may include further operations, features, means, or instructions for transmitting, via the first signal path, one or more third CSI-RSs that may be spatially and temporally precoded and transmitting, via the second signal path, one or more fourth CSI-RSs that may be spatially and temporally precoded.

In some examples of the method, apparatuses, and non-transitory computer-readable medium described herein, receiving the signaling indicative of the first Doppler frequency shift and the second Doppler frequency shift may include operations, features, means, or instructions for receiving an indication of a CSI-RS having a lowest average Doppler frequency shift selected from a first set of CSI-RSs that includes the first CSI-RS and the one or more third CSI-RSs, the first Doppler frequency shift including the lowest average Doppler frequency shift associated with the first set of CSI-RSs and receiving an indication of a CSI-RS having a lowest average Doppler frequency shift selected from a second set of CSI-RSs that includes the second CSI-RS and the one or more fourth CSI-RSs, the second Doppler frequency shift including the lowest average Doppler frequency shift associated with the second set of CSI-RSs.

In some examples of the method, apparatuses, and non-transitory computer-readable medium described herein, each CSI-RS of the first set of CSI-RSs may be spatially precoded using a first spatial precoding, each CSI-RS of the second set of CSI-RSs may be spatially precoded using a second spatial precoding, each CSI-RS of the first set of CSI-RSs may be temporally precoded using different temporal precoding, and each CSI-RS of the second set of CSI-RSs may be temporally precoded using different temporal precoding.

In some examples of the method, apparatuses, and non-transitory computer-readable medium described herein, the first CSI-RS corresponds to a first CSI-RS port, the one or more third CSI-RSs each correspond to a respective third CSI-RS port, the first CSI-RS port and the one or more third CSI-RS ports correspond to a first CSI-RS port group or a first CSI-RS resource, the second CSI-RS corresponds to a second CSI-RS port, the one or more fourth CSI-RSs each correspond to a respective fourth CSI-RS port, and the second CSI-RS port and the one or more fourth CSI-RS ports correspond to a second CSI-RS port group or a second CSI-RS resource.

In some examples of the method, apparatuses, and non-transitory computer-readable medium described herein, the first CSI-RS corresponds to a first CSI-RS resource, the one or more third CSI-RSs each correspond to a respective third CSI-RS resource, the first CSI-RS resource and the one or more third CSI-RS resources correspond to a first CSI-RS resource set, the second CSI-RS corresponds to a second CSI-RS resource, the one or more fourth CSI-RSs each correspond to a respective fourth CSI-RS resource, and the second CSI-RS resource and the one or more fourth CSI-RS resources correspond to a second CSI-RS resource set.

In some examples of the method, apparatuses, and non-transitory computer-readable medium described herein, receiving the signaling indicative of the first Doppler frequency shift and the second Doppler frequency shift may include operations, features, means, or instructions for receiving an indication of a first temporal parameter for a first precoder associated with the first CSI-RS, the first temporal parameter based on the first Doppler frequency shift for the first CSI-RS and receiving an indication of a second temporal parameter for a second precoder associated with the second CSI-RS, the second temporal parameter based on the second Doppler frequency shift for the second CSI-RS.

In some examples of the method, apparatuses, and non-transitory computer-readable medium described herein, the first temporal and spatial precoding for the downlink signal uses the first precoder and the first temporal parameter and the second temporal and spatial precoding for the downlink signal uses the second precoder and the second temporal parameter.

In some examples of the method, apparatuses, and non-transitory computer-readable medium described herein, the downlink signal includes a CSI-RS, a demodulation reference signal, a downlink control channel, a downlink shared channel, or any combination thereof.

### BRIEF DESCRIPTION OF THE DRAWINGS

FIG. 1 illustrates an example of a wireless communications system that supports temporal and spatial precoding of downlink signals in accordance with aspects of the present disclosure.

FIG. 2 illustrates an example of a wireless communications system that supports temporal and spatial precoding of downlink signals in accordance with aspects of the present disclosure.

FIGS. 3A and 3B illustrate examples of wireless communications systems that support temporal and spatial precoding of downlink signals in accordance with aspects of the present disclosure.

FIGS. 4A and 4B illustrate examples of wireless communications systems that support temporal and spatial precoding of downlink signals in accordance with aspects of the present disclosure.

FIG. 5 illustrates an example of a flow diagram that supports temporal and spatial precoding of downlink signals in accordance with aspects of the present disclosure.

FIG. 6 illustrates an example of a wireless communications system that supports temporal and spatial precoding of downlink signals in accordance with aspects of the present disclosure.

FIG. 7 illustrates an example of a process flow that supports temporal and spatial precoding of downlink signals in accordance with aspects of the present disclosure.

FIGS. 8 and 9 show block diagrams of devices that support temporal and spatial precoding of downlink signals in accordance with aspects of the present disclosure.

FIG. 10 shows a block diagram of a communications manager that supports temporal and spatial precoding of downlink signals in accordance with aspects of the present disclosure.

FIG. 11 shows a diagram of a system including a device that supports temporal and spatial precoding of downlink signals in accordance with aspects of the present disclosure.

FIGS. 12 and 13 show block diagrams of devices that support temporal and spatial precoding of downlink signals in accordance with aspects of the present disclosure.

FIG. 14 shows a block diagram of a communications manager that supports temporal and spatial precoding of downlink signals in accordance with aspects of the present disclosure.

FIG. 15 shows a diagram of a system including a device that supports temporal and spatial precoding of downlink signals in accordance with aspects of the present disclosure.

FIGS. 16 through 23 show flowcharts illustrating methods that support temporal and spatial precoding of downlink signals in accordance with aspects of the present disclosure.

### DETAILED DESCRIPTION

A base station and a user equipment (UE) may communicate in a downlink direction (e.g., among other examples of communication directions) via multiple paths or multiple signal layers (e.g., via multiple-input multiple-output (MIMO) communications). MIMO transmissions may, for example, include transmissions via multiple signal paths, via multiple beams, or both. For example, the base station may transmit a downlink transmission at least partially concurrently (e.g., at least partially overlapping) via a first cluster of rays in, or close to, a first direction (e.g., a first signal path) and via a second cluster of rays in, or close to, a second direction (e.g., a second signal path). As described herein, a transmission or channel communicated via a signal path or a cluster may represent a signal, transmission, or channel that is largely or mainly communicated via the signal path or the cluster (e.g., where some portions of the signal, transmission, or channel may not necessarily be communicated via the signal path or the cluster). As described herein, a cluster may represent a group of rays of a downlink signal transmitted via a signal path. The signals transmitted by the base station (e.g., via the respective clusters) may arrive at the UE at least partially concurrently, such that the associated downlink transmission may represent an example of a multi-path transmission (e.g., a transmission via multiple signal paths, a MIMO transmission).

A performance of MIMO transmissions (e.g., a communication quality of the MIMO transmissions) may be based on an accuracy of associated channel state information (CSI). However, a time gap may exist between determination (e.g., calculation) of CSI at the UE (e.g., based on CSI reference signals (CSI-RSs) received from the base station) and application of the CSI at the base station (e.g., for one or more downlink transmissions). In cases where communications between the UE and the base station experience a relatively higher time domain selectivity (e.g., if the time domain selectivity exceeds a threshold), the CSI may become outdated between determination (e.g., calculation) of the CSI at the UE and application of the CSI at the base station. The time domain selectivity (e.g., channel variation over time) or time domain correlation of such communications may be based on a spectrum of the channel, such as the Doppler spectrum of the channel, which may be based on a movement of the UE.

A relatively higher speed of movement of the UE may result in relatively larger Doppler shifts in the Doppler spectrum, which may increase the time domain selectivity for a corresponding downlink channel. The increased time domain selectivity may result in associated CSI becoming outdated relatively sooner, and in a corresponding reduction in spectral efficiency. For example, a communication quality of one or more downlink transmissions may decrease based on the outdating of the CSI determined and reported by the UE.

The present disclosure provides techniques for reducing the time domain selectivity of wireless communication channels, which may reduce outdating of CSI and increase communication quality. For example, the UE and the base station may perform one or more techniques to align (e.g., substantially or closely align) the Doppler frequencies (e.g., center or average Doppler frequencies) across different clusters or signal paths. By reducing a span or scope of the Doppler frequencies (among other aspects) within the Doppler spectrum, the time domain selectivity of a corresponding channel may be reduced, which may also reduce outdating of the corresponding CSI and may increase communication quality. To align the Doppler frequencies of a downlink transmission, the base station may spatially precode multiple CSI-RSs (e.g., at least one spatially precoded CSI-RS corresponding to each signal path or cluster) and transmit the spatially precoded CSI-RSs to the UE.

For example, the base station may transmit a first CSI-RS that may be spatially precoded for transmission (e.g., mainly, largely) via the first signal path, and may transmit a second CSI-RS that may be spatially precoded for transmission (e.g., mainly, largely) via the second signal path. Based on the spatially precoded CSI-RSs, the UE may determine a parameter associated with a Doppler shift, such as a mean or average Doppler shift (e.g., Doppler frequency value or Doppler frequency shift from a center frequency) for each cluster or signal path.

In a first example, the UE may report each average Doppler shift to the base station via signaling, and the base station may use the reported average Doppler shifts to spatially and temporally precode one or more CSI-RSs transmitted to the UE. In a second example, the UE may receive multiple CSI-RSs (e.g., temporally and spatially precoded CSI-RSs) per signal path and may determine an average Doppler shift for each CSI-RS. In such cases, the UE may select and report (to the base station and for each signal path) a CSI-RS having a lowest average Doppler shift. The base station may use the reported CSI-RSs to spatially and temporally precode one or more CSI-RSs transmitted to the UE.

Based on the one or more precoded CSI-RSs (e.g., in the first or second example), the UE may report feedback to the base station, and the base station may use the feedback to spatially and temporally precode one or more downlink channels for transmission to the UE (e.g., on top of one or more other precoding schemes). The spatially and temporally precoded downlink channel (s) may be aligned (e.g., substantially or closely aligned) in a Doppler frequency domain, which may reduce the time domain selectivity for the downlink channel(s).

In a third example, the UE may use the determined average Doppler shifts to determine (e.g., calculate) and report a temporal precoding parameter for each signal path. The base station may use the reported parameters to spatially and temporally precode one or more channels for transmission to the UE. The spatially and temporally precoded downlink channel(s) may be aligned (e.g., substantially or closely aligned) in Doppler frequency domain, which may reduce the time domain selectivity for the downlink channel(s).

Aspects of the disclosure are initially described in the context of wireless communications systems. Aspects of the disclosure are further illustrated by and described with reference to a flow diagram, a process flow, apparatus diagrams, system diagrams, and flowcharts that relate to temporal and spatial precoding of downlink signals.

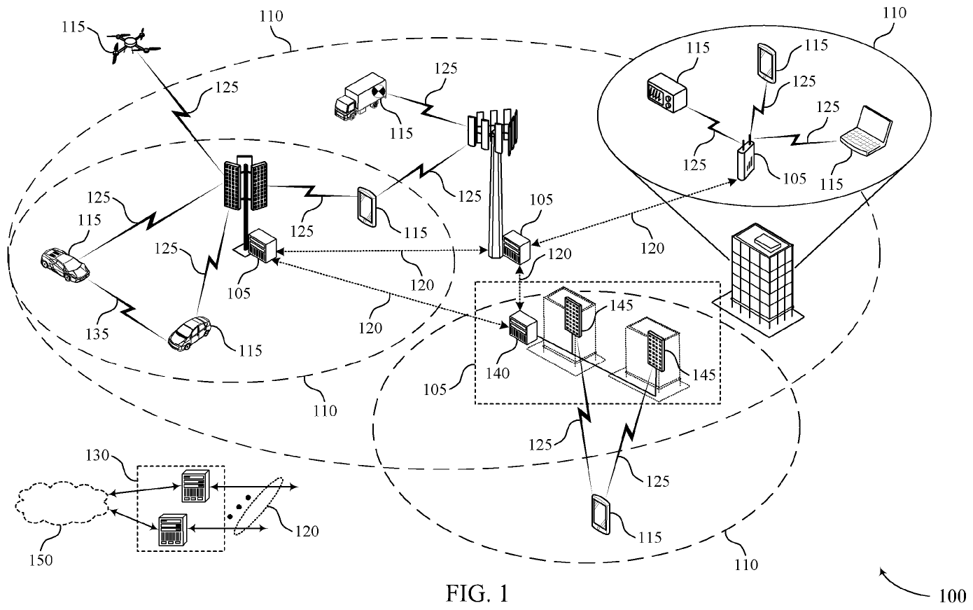

FIG. 1 illustrates an example of a wireless communications system 100 that supports temporal and spatial precoding of downlink signals in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may be a sixth generation (6G) system, such as a 6G holographic MIMO system. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, MIMO communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

A UE 115 may perform CSI reporting with a base station 105, where the CSI reporting may include receiving one or more CSI-RSs, measuring one or more parameters based on the CSI-RS(s), and reporting the one or more parameters to the base station 105. The base station 105 may use the reported CSI to configure downlink communication parameters for communications with the UE 115. A CSI-RS may be transmitted via a CSI-RS resource or a CSI-RS resource set, where a CSI-RS resource set may include multiple CSI-RS resources and a CSI-RS resource may include multiple CSI-RS ports (e.g., an antenna port or logical entity at the base station 105 used for CSI-RS transmission). The CSI-RS ports within a CSI-RS resource may also, in some cases, be grouped into multiple CSI-RS port groups, where each CSI-RS port group may include multiple CSI-RS ports.

A base station 105 may spatially precode multiple CSI-RSs and transmit the spatially precoded CSI-RSs to a UE 115, where at least one spatially precoded CSI-RS may correspond to one of multiple signal paths. Based on the spatially precoded CSI-RSs, the UE 115 may determine a mean or average Doppler shift for each signal path. The UE 115 may transmit, to the base station 105, signaling indicative of (e.g., an indication of) the respective average Doppler shifts for each signal path. Based on the indication of the Doppler shifts, the base station 105 may spatially and temporally precode one or more downlink transmissions to the UE 115, which may reduce a time domain selectivity of the one or more downlink transmissions.

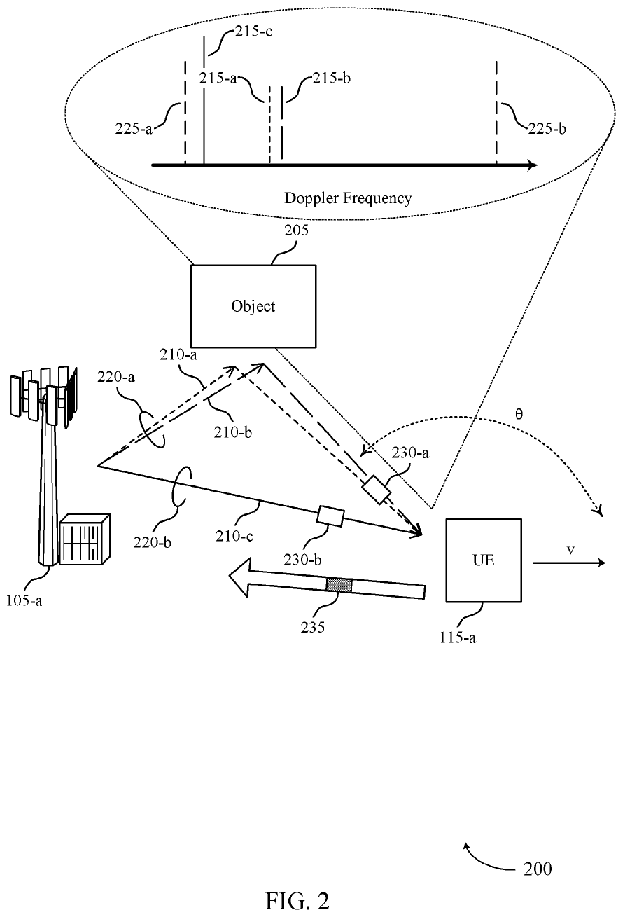

FIG. 2 illustrates an example of a wireless communications system 200 that supports temporal and spatial precoding of downlink signals in accordance with aspects of the present disclosure. In some examples, wireless communications system 200 may implement or be implemented by one or more aspects of wireless communications system 100. For example, wireless communications system 200 may include a base station 105-a and a UE 115-a, which may be examples of a base station 105 and a UE 115 described with reference to FIG. 1. Base station 105-a and UE 115-a may communicate in the downlink (e.g., among other examples) via MIMO transmissions. The MIMO transmissions (e.g., MIMO in 4G, massive MIMO in 5G, holographic MIMO in 6G systems) may increase a spectral efficiency of communications between base station 105-a and UE 115-a, where the spectral efficiency may be proportional to a number of antennas of base station 105-a, UE 115-a, or both.

In some cases, MIMO transmissions may take place in higher frequency bands (e.g., due to a higher usage of lower frequency spectrum). However, higher frequency transmissions may experience relatively constrained coverage due to higher propagation attenuation. Higher frequency spectrum may also support a denser deployment of antennas for a given aperture size, and beamforming of MIMO transmissions (e.g., massive and/or holographic MIMO) may extend a coverage and propagation distance of the higher frequency transmissions.

MIMO transmissions may, for example, include transmissions via multiple signal paths, via multiple beams, or both. For example, base station 105-a may transmit a downlink channel at least partially concurrently via a first cluster 220-a of rays 210 in a first direction (e.g., which may reflect or scatter off an object 205, or based on another phenomenon) and a second cluster 220-b of rays 210 in a second direction, where the first cluster 220-a may include rays 210-a and 210-b and the second cluster 220-b may include ray 210-c (e.g., among other rays 210). As described herein, a cluster 220 may represent a group of rays, of a downlink signal transmitted via a signal path. The rays 210 transmitted by base station 105-a (e.g., via the respective clusters 220) may arrive at UE 115-a at least partially concurrently, such that the associated downlink channel transmission may represent an example of a multi-path transmission (e.g., a transmission via multiple signal paths, a MIMO transmission).

A performance of MIMO transmissions (e.g., a communication quality of the MIMO transmissions) may be based on an accuracy of associated CSI (e.g., as indicated by the Shannon formula). However, a time gap may exist between calculation of CSI at UE 115-a (e.g., based on CSI-RS received from base station 105-a) and application of the CSI at base station 105-a (e.g., for one or more downlink transmissions). For example, the time gap may be based on a time for transmission of the CSI from UE 115-a to base station 105-a, a time for processing of CSI at base station 105-a, or both. In cases where communications between UE 115-a and base station 105-a experience a relatively higher time domain selectivity (e.g., if the time domain selectivity exceeds a threshold), the CSI may become outdated between calculation of the CSI and application of the CSI. The time domain selectivity (e.g., channel variation over time), or time domain correlation, of such communications may be based on the Doppler spectrum of the channel (e.g., may be a Fourier transform of the Doppler spectrum of the channel, according to the Wiener-Khinchin theorem), which may be based on a movement of UE 115-a.

In the Doppler spectrum of a channel, each component (e.g., Doppler frequency 215) of the Doppler spectrum may correspond with a ray 210 of an associated a downlink channel transmission. For example, a first Doppler frequency 215-a may correspond to ray 210-a, a second Doppler frequency 215-b may correspond to ray 210-b, and a third Doppler frequency 215-c may correspond to ray 210-c. Doppler frequencies 225-a and 225-b may represent a maximum Doppler frequency (e.g., maximum Doppler shift) in a negative direction and positive direction of the Doppler spectrum, respectively. Each Doppler frequency 215 may be associated with the corresponding ray 210 using an equation such as Equation (1):

$${f}_{d} = \frac{v}{c} f cos θ \qquad ( 1 )$$

where f_{d} may represent the Doppler frequency 215, v may represent a speed of UE 115-a, c may represent the speed of light, f may represent a frequency of a carrier (e.g., a center frequency of a carrier) used for transmission of the associated downlink channel, cos may represent a cosine function, and θ may represent an angle between an arrival direction of the associated ray 210 and a direction of movement of UE 115-a.

A higher speed of movement of UE 115-a may therefore result in relatively larger shifts in the Doppler spectrum. Further, if different rays 210 arrive at UE 115-a at different angles (e.g., having different values of θ), the Doppler spectrum may include multiple components. Accordingly, a higher speed of movement of UE 115-a, a larger variation of angles of arrival (e.g., θ) at UE 115-a, or both, may increase the time domain selectivity of a corresponding downlink channel, which may result in the CSI becoming outdated relatively sooner and a corresponding reduction in spectral efficiency. For example, a communication quality of one or more downlink channels may decrease based on the outdating of the CSI determined and reported by UE 115-a.

The present disclosure provides techniques for reducing the time domain selectivity of MIMO channels, which may reduce outdating of CSI and increase communication quality. For example, UE 115-a and base station 105-a may perform one or more techniques to align (e.g., substantially or closely align), or reduce a span or scope of, the Doppler frequencies 215 (e.g., center or average Doppler frequencies) across different clusters 220. By reducing a span or scope of the Doppler frequencies 215 within the Doppler spectrum, the time domain selectivity of a corresponding channel may be reduced, which may reduce outdating of the corresponding CSI and increase communication quality.

In order to align, or reduce a span or scope of, the Doppler frequencies 215 of a downlink channel, base station 105-a may spatially precode multiple CSI-RSs 230 (e.g., one spatially precoded CSI-RS 230 corresponding to each signal path or cluster 220) and transmit the spatially precoded CSI-RSs 230 to UE 115-a. For example, base station 105-a may transmit a first CSI-RS 230-a that may be spatially precoded for transmission (e.g., mainly, largely) via cluster 220-a (e.g., for transmission mainly via a signal path associated with cluster 220-a), and may transmit a second CSI-RS 230-b that may be spatially precoded for transmission (e.g., mainly, largely) via cluster 220-b (e.g., for transmission mainly via a signal path associated with cluster 220-b). Based on the spatially precoded CSI-RSs 230, UE 115-a may determine a mean or average Doppler shift (e.g., Doppler frequency value or Doppler frequency shift from a center frequency, f_{c}) for each cluster 220 (e.g., for each signal path). Each average Doppler shift (e.g., averaged Doppler shift), for example, may represent an average Doppler shift across all of the rays 210 associated with a respective cluster 220.

In some cases, base station 105-a may not spatially precode the multiple CSI-RSs 230. In such cases, UE 115-a may determine a mean or average Doppler shift for each cluster 220 (e.g., signal path) by estimating a Doppler spectrum. UE 115-a may observe multiple peaks within the Doppler spectrum, where each peak may correspond to an average Doppler shift of a respective cluster 220 (e.g., signal path). For example, a coordinate of a peak in the x-axis (e.g., in the Doppler domain) may represent an average Doppler shift for a respective cluster 220. In some cases, estimating the Doppler spectrum, and the respective Doppler shifts for each cluster 220, may experience an increased accuracy based on spatially precoding the multiple CSI-RSs 230. For example, the peaks of the Doppler spectrum for spatially precoded CSI-RSs 230 may be more distinct (e.g., sharp, clear) than the peaks of the Doppler spectrum for non-spatially precoded CSI-RSs 230 and may support a higher precision for determining the respective average Doppler shifts, although either method may support estimation of a respective, average Doppler shift for each cluster 220 (e.g., signal path).

In a first example, UE 115-a may report each average Doppler shift to base station 105-a via signaling 235, and base station 105-a may use the reported Doppler shifts to spatially and temporally precode one or more CSI-RSs 230 transmitted to UE 115-a. Based on the one or more spatially and temporally precoded CSI-RSs 230, UE 115-a may perform PMI feedback (e.g., may transmit the PMI feedback to base station 105-a), and base station 105-a may use the PMI feedback to spatially and temporally precode one or more downlink channels for transmission to UE 115-a (e.g., on top of one or more other precoding schemes). The spatially and temporally precoded downlink channel(s) may be aligned (e.g., substantially or closely aligned), or have a reduced span or scope, in a Doppler frequency domain, which may reduce the time domain selectivity of the downlink channel(s).

In a second example, UE 115-a may receive multiple CSI-RS 230 per cluster 220 (e.g., per signal path) and may determine an average Doppler shift for each CSI-RS 230. In such cases, UE 115-a may select and report (e.g., via signaling 235), to base station 105-a and for each cluster 220 (e.g., each signal path), a CSI-RS 230 having a lowest average Doppler shift. Base station 105-a may use the reported CSI-RSs 230 to spatially and temporally precode one or more CSI-RSs 230 transmitted to UE 115-a. Based on the one or more temporally and spatially precoded CSI-RSs 230, UE 115-a may perform PMI feedback (e.g., may transmit the PMI feedback to base station 105-a), and base station 105-a may use the PMI feedback to spatially and temporally precode one or more downlink channels for transmission to UE 115-a (e.g., on top of one or more other precoding schemes). The spatially and temporally precoded downlink channel (s) may be aligned (e.g., substantially or closely aligned) in Doppler frequency domain, which may reduce the time domain selectivity of the downlink channel(s).

In a third example, UE 115-a may use the determined average Doppler shifts to calculate and report (e.g., via signaling 235) a respective PMI (e.g., a PMI based on temporal and spatial information) for each cluster 220 (e.g., each signal path). Base station 105-a may use the reported PMI to spatially and temporally precode one or more downlink channels for transmission to UE 115-a. The spatially and temporally precoded downlink channel (s) may be aligned (e.g., substantially or closely aligned) in Doppler frequency domain, which may reduce the time domain selectivity of the downlink channel(s).

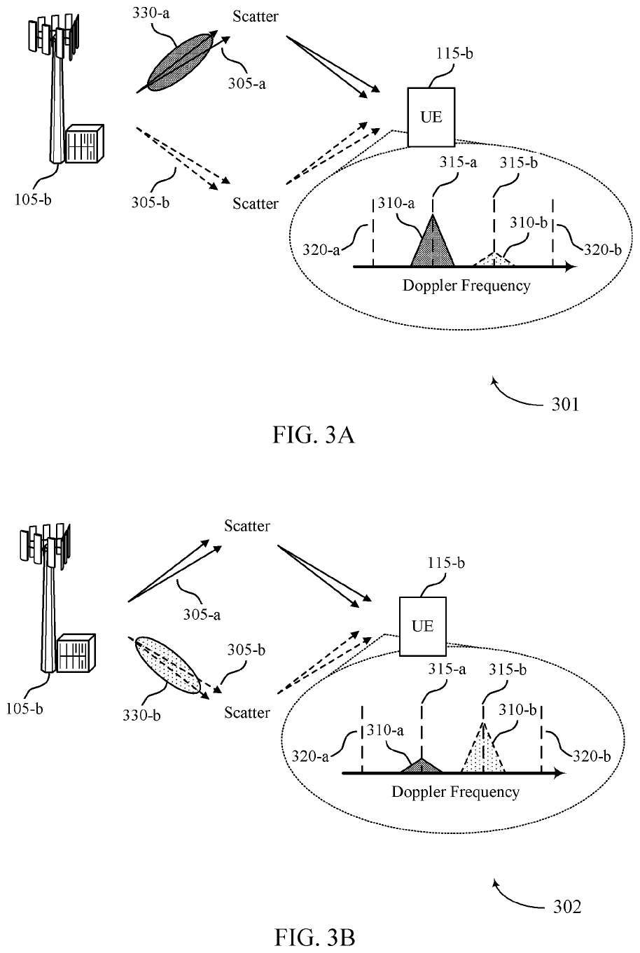

FIGS. 3A and 3B illustrate examples of wireless communications systems 301 and 302 that support temporal and spatial precoding of downlink signals in accordance with aspects of the present disclosure. Some aspects of wireless communications systems 301 and 302 may implement or be implemented by wireless communications system 100 or 200. For example, wireless communications systems 301 and 302 may include a base station 105-b and a UE 115-b, which may represent examples of a base station 105 and a UE 115 described with reference to FIGS. 1 and 2. As described with reference to FIG. 2, base station 105-b may spatially precode multiple CSI-RSs (e.g., each spatially precoded CSI-RS corresponding to a signal path 305 or cluster) and transmit the spatially precoded CSI-RSs to UE 115-b. Based on the spatially precoded CSI-RSs, UE 115-b may determine a respective mean or average Doppler shift for multiple signal paths 305 (e.g., may determine an average across all of the rays associated with a respective signal path 305), where the average Doppler shift may be a CSI quantity (e.g., a configured, reportable, CSI quantity).

For example, base station 105-b may transmit a respective, spatially precoded (e.g., or non-spatially precoded) CSI-RS port (e.g., an antenna port or logical entity at the base station 105 used for CSI-RS transmission) for each signal path 305 (e.g., a cluster), or may transmit a respective, spatially precoded (e.g., or non-spatially precoded) CSI-RS resource for each signal path 305 (e.g., a cluster). The spatial precoding of the respective CSI-RS port or resource may be determined by a departure angle of the associated signal path 305 and may alter an observed Doppler spectrum at UE 115-b such that the observed Doppler spectrum (e.g., a shift from an original or center frequency) for a respective CSI-RS port or resource may be associated with one signal path 305. The Doppler spectrum may be estimated by UE 115-b by calculating the time-domain correlation of the channels on CSI-RS REs, R (n), where n is the number of OFDM symbols. For example, DFT may be performed on R(n) to obtain the Doppler spectrum, D(f), or a eigenvalue decomposition (EVD) may be performed on R (n) to obtain the Doppler spectrum, D(f) (e.g., among other examples). If each signal path 305 is associated with a respective CSI-RS port, the CSI-RS ports for multiple signal paths 305 may be grouped into a CSI-RS port group or a CSI-RS resource. If each signal path 305 is associated with a respective CSI-RS resource, the CSI-RS resources for multiple signal paths 305 may be grouped into a CSI-RS resource set.

As illustrated by FIG. 3A, a first CSI-RS port or resource may be spatially precoded to mostly or fully follow a beam 330-a, which may correspond to a signal path 305-a. Similarly, as illustrated by FIG. 3B, a second CSI-RS port or resource may be spatially precoded to mostly or fully follow a beam 330-b, which may correspond to a signal path 305-b.

A signal (e.g., CSI-RS) carrying the first CSI-RS port or resource may be scattered by an object or other factor (e.g., or in some cases may not be scattered) and may reach and be received by UE 115-b. UE 115-b may observe a Doppler spectrum segment 310-a (e.g., having a center Doppler or average Doppler shift 315-a) associated with the first CSI-RS port or resource, which may correspond to a Doppler shift corresponding to signal path 305-a. An observed Doppler spectrum segment 310-b associated with signal path 305-b may be minimized or eliminated, for example, based on the spatial precoding of the first CSI-RS port or resource. The observed Doppler spectrum segments 310 may be within or between a lowest Doppler shift 320-a and a highest Doppler shift 320-b, which may represent a center frequency minus or plus a maximum Doppler shift.

A signal (e.g., CSI-RS) carrying the second CSI-RS port or resource may be scattered by an object or other factor (e.g., or in some cases may not be scattered) and may reach and be received by UE 115-b. UE 115-b may observe a Doppler spectrum segment 310-b (e.g., having a center Doppler or average Doppler shift 315-b) associated with the second CSI-RS port or resource, which may correspond to a Doppler spectrum segment corresponding to signal path 305-b. An observed Doppler spectrum segment 310-a associated with signal path 305-a may be minimized or eliminated, for example, based on the spatial precoding of the second CSI-RS port or resource.

It is to be understood that the examples described herein may apply to any number of signal paths 305 without departing from the scope of the present disclosure. For example, although FIGS. 3A and 3B illustrate two signal paths 305, any number of signal paths 305 may be used to transmit spatially and temporally precoded CSI-RS to UE 115-b.

Based on receiving the spatially precoded (e.g., or non-spatially precoded) CSI-RSs (e.g., CSI-RS ports or resources) via the respective signal paths 305, UE 115-b may calculate and report a respective average Doppler shift for each signal path 305 (e.g., for each CSI-RS port or each CSI-RS resource). For example, UE 115-b may calculate and report a respective mean Doppler shift (e.g., fₛ) for each signal path 305 (e.g., may report CSI for each corresponding CSI-RS, including a respective mean Doppler shift), or may calculate and report a respective root-mean-square Doppler spread (e.g., fᵣₘₛ) for each signal path 305 (e.g., may report CSI for each corresponding CSI-RS, including a respective root-mean-square Doppler spread). In some cases, UE 115-b may calculate and report a normalized version of fₛ, fᵣₘₛ, or both. For example, UE 115-b may divide fₛ, fᵣms, or both, by a maximum Doppler shift to normalize fₛ, fᵣₘₛ, or both.

A mean Doppler shift may be calculated or determined using an equation such as Equation (2):

$${f}_{s} = \frac{{\sum }_{i = 1}^{N} {f}_{i} {P}_{i}}{{\sum }_{i = 1}^{N} {P}_{i}} \qquad ( 2 )$$

where fₛ represents the mean Doppler shift for a respective signal path 305 (e.g., and a respective Doppler spectrum segment 310), i represents an ith strongest Doppler component observed or detected by UE 115-b (e.g., corresponding to a ray of the signal path 305), N represents a positive integer configured by base station 105-b (e.g., configured for Doppler reporting), fᵢ represents a Doppler shift of the ith strongest Doppler component, and Pᵢ represents a power of the ith strongest Doppler component. Values of Pᵢ may be determined from the Doppler spectrum according to Pᵢ=|D(fᵢ)|².

Similarly, a root-mean-square Doppler spread may be calculated or determined using an equation such as Equation (3):

$${f}_{rms} = \sqrt{\frac{{\sum }_{i = 1}^{N} {( {f}_{i} - {f}_{s} )}^{2} {P}_{i}}{{\sum }_{i = 1}^{N} {P}_{i}}} \qquad ( 3 )$$

where fᵣₘₛ represents the root-mean-square Doppler spread for a respective signal path 305 (e.g., and a respective Doppler spectrum segment 310), fₛ represents the mean Doppler shift for a respective signal path 305 (e.g., as determined using Equation (2)), i represents an ith strongest Doppler component observed or detected by UE 115-b (e.g., corresponding to a ray of the signal path 305), N represents a positive integer configured by base station 105-b (e.g., configured for Doppler reporting), fᵢ represents a Doppler shift of the ith strongest Doppler component, and Pᵢ represents a power of the ith strongest Doppler component. Values of Pᵢ may be determined from the Doppler spectrum according to Pᵢ=|D(fᵢ)|².

As described with reference to FIG. 2, UE 115-b may report each average Doppler shift (e.g., mean Doppler shift, root-mean-square Doppler spread, or normalized versions thereof) to base station 105-b (e.g., one average Doppler shift per signal path 305). Base station 105-b may use the reported Doppler shifts to spatially and temporally precode one or more subsequent CSI-RSs transmitted to UE 115-b. For example, base station 105-b may configure and transmit N spatially and temporally precoded CSI-RS ports in a configured CSI-RS resource, such as using an equation corresponding to, or similar to, Equation (4):

$${W}_{S T} ( t ) = [ {w}_{1} {e}^{- j 2 π {f}_{{s}_{1}} t} , {w}_{2} {e}^{- j 2 {π f}_{{s}_{2}} t} , … , {w}_{n} {e}^{- j 2 π {f}_{{s}_{n}} t} , … , {w}_{N} {e}^{- j 2 π {f}_{{s}_{N}} t} ] \qquad ( 4 )$$

where W_{ST}(t) represent the spatial and temporal precoder, n represents a cluster index (e.g., signal path 305 index), N represents a number of selected clusters (e.g., signal paths 305) for transmission of the CSI-RS(s) (e.g., one cluster per CSI-RS port), wₙ represents a spatial precoder corresponding to the nth cluster, fₛ_{ₙ} represents an average Doppler shift (e.g., mean Doppler shift, root-mean-square Doppler spread, or normalized versions thereof) corresponding to the nth cluster, and t represents a time variable based on a symbol length (e.g., T_{sym}) and a symbol index (e.g., l), where t=lT_{sym}. For each CSI-RS port, a time domain interval (e.g., L_{CSI-RS}) between adjacent CSI-RS symbols may satisfy

$${L}_{CSI - RS} \leq \frac{1}{\{ {max}_{n} {f}_{rms , n} \} {T}_{s y m}} ,$$

where fᵣₘₛ represents a root-mean-square Doppler spread.

Temporally and spatially precoding the one or more subsequent CSI-RSs may align the Doppler spectrum segments 310 of the one or more subsequent CSI-RSs, for example, based on using a precoder such as illustrated by Equation (4). In such cases, a Doppler shift of each signal path 305 may be accounted for in the temporal and spatial precoding, which may more closely align (e.g., reduce a span or scope of) the respective Doppler shifts in a Doppler spectrum (e.g., to a center frequency) and may reduce a time domain selectivity of the subsequent CSI-RS(s) (e.g., based on a reduce span of the Doppler spectrum segments 310, or Doppler shifts, which may reduce time domain selectivity according to the Wiener-Khinchin theorem). Based on the one or more subsequent CSI-RSs, UE 115-b may perform PMI feedback (e.g., may transmit the PMI feedback to base station 105-b), and base station 105-b may use the PMI feedback to spatially and temporally precode one or more downlink transmissions to UE 115-b, where the spatially and temporally precoded downlink transmission(s) may also have a reduced span or scope in the Doppler spectrum and a reduced time domain selectivity (e.g., based on applying a spatial and temporal precoder, such as given by Equation (4)).

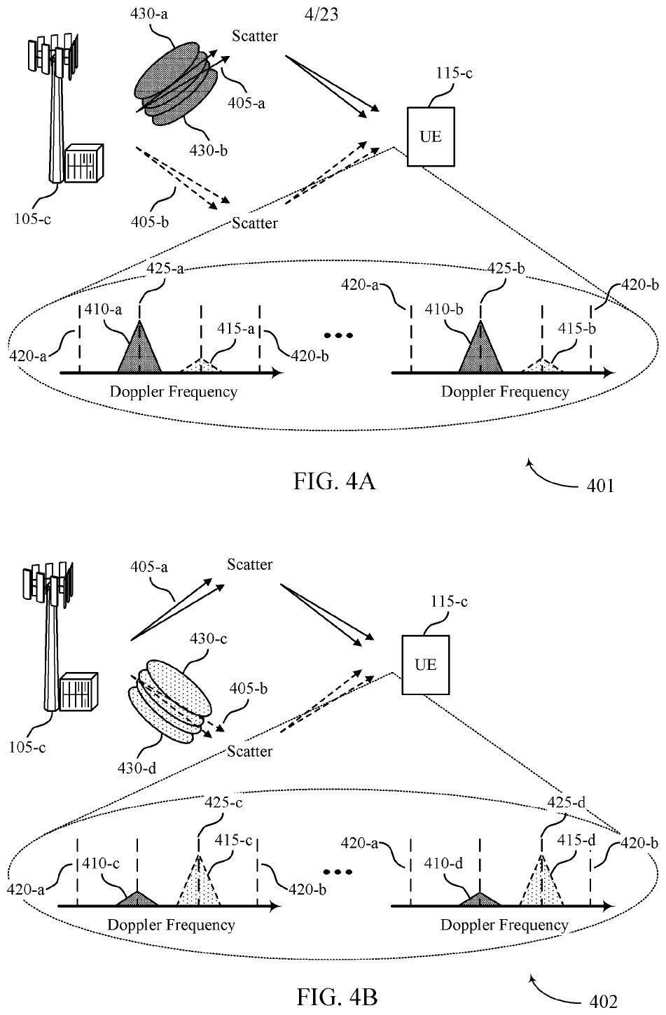

FIGS. 4A and 4B illustrate examples of wireless communications systems 401 and 402 that support temporal and spatial precoding of downlink signals in accordance with aspects of the present disclosure. Some aspects of wireless communications systems 401 and 402 may implement or be implemented by wireless communications system 100 or 200. For example, wireless communications systems 401 and 402 may include a base station 105-c and a UE 115-c, which may represent examples of a base station 105 and a UE 115 described with reference to FIGS. 1-3. Base station 105-c may spatially and temporally precode (e.g., or may not spatially precode, but may temporally precode) multiple CSI-RSs (e.g., with one set of multiple spatially and temporally precoded CSI-RSs corresponding to a signal path 405 or cluster) and transmit the spatially and temporally precoded (e.g., or temporally precoded) CSI-RSs to UE 115-c. Based on the spatially and temporally precoded (e.g., or temporally precoded) CSI-RSs, UE 115-c may determine a respective mean or average Doppler shift for each CSI-RS (e.g., may determine an average across all of the rays of the CSI-RS associated with a respective signal path 405), where the average Doppler shift may be a CSI quantity (e.g., a configured, reportable, CSI quantity).

For example, base station 105-c may transmit multiple spatially and temporally precoded CSI-RSs for each signal path 405 (e.g., a cluster), where each precoded CSI-RS may be associated with a respective beam 430. For example, base station 105-c may transmit a first spatially and temporally precoded CSI-RS via a beam 430-a, may transmit a second spatially and temporally precoded CSI-RS via a beam 430-b, and so on. Each spatially and temporally precoded CSI-RS may correspond to a respective CSI-RS port or to a respective CSI-RS resource. If each CSI-RS corresponds to a CSI-RS port, the multiple CSI-RSs transmitted via a same signal path 405 (e.g., cluster) may correspond to a same CSI-RS port group or a same CSI-RS resource. If each CSI-RS corresponds to a CSI-RS resource, the multiple CSI-RSs transmitted via a same signal path 405 (e.g., cluster) may correspond to a same CSI-RS resource set.

A spatial and temporal precoder for a respective CSI-RS (e.g., CSI-RS port or CSI-RS resource) may be determined using an equation such as Equation (5):

$${w}_{n} {e}^{- j 2 π {f}_{s} t} \qquad ( 5 )$$

where wₙ represents spatial precoding (e.g., one or more spatial precoding parameters) that may be applied to all CSI-RS (e.g., CSI-RS ports, CSI-RS resources) transmitted via a same signal path 405 and e^{-j2πf}^{ₛ}^{t} represents temporal precoding (e.g., one or more temporal precoding parameters) that may be specific to a CSI-RS (e.g., a CSI-RS port, CSI-RS resource), such as based on a respective Doppler shift (e.g., fₛ) applied to a given CSI-RS.

As described herein, the spatial precoding (e.g., wₙ) of a respective CSI-RS port or resource may be determined by a departure angle of the associated signal path 405. Based on the respective spatial and temporal precoding applied to each CSI-RS, each CSI-RS (e.g., CSI-RS port, CSI-RS resource) may be associated with a different Doppler shift. For example, as illustrated by FIG. 4A, a first CSI-RS port or resource associated with a signal path 405-a may be spatially and temporally precoded to mostly or fully follow a beam 430-a, which may correspond to a signal path 405-a. Similarly, one or more other CSI-RS ports or resources associated with signal path 405-a may be respectively spatially and temporally precoded up to a last CSI-RS port or resource associated with signal path 405-a. The last CSI-RS port or resource may, for example, be spatially and temporally precoded to mostly or fully follow a beam 430-b corresponding to signal path 405-a.

A signal (e.g., CSI-RS) carrying the first CSI-RS port or resource associated with signal path 405-a may be scattered by an object or other factor (e.g., or in some cases may not be scattered) and may reach and be received by UE 115-c. UE 115-c may observe a Doppler spectrum segment 410-a (e.g., having a center Doppler or average Doppler shift 425-a) associated with the first CSI-RS port or resource, which may correspond to a Doppler shift corresponding to signal path 405-a and beam 430-a. An observed Doppler spectrum segment 415-a associated with signal path 405-b may be minimized or eliminated, for example, based on the spatial precoding of the first CSI-RS port or resource.

A signal carrying the last CSI-RS port or resource associated with signal path 405-a may be scattered by an object or other factor (e.g., or in some cases may not be scattered) and may reach and be received by UE 115-c. UE 115-c may observe a Doppler spectrum segment 410-b (e.g., having a center Doppler or average Doppler shift 425-b) associated with the last CSI-RS port or resource, which may correspond to a Doppler shift corresponding to signal path 405-a and beam 430-b. An observed Doppler spectrum segment 415-b associated with signal path 405-b may be minimized or eliminated, for example, based on the spatial precoding of the last CSI-RS port or resource.

Similarly, any other CSI-RS (e.g., between the first and last CSI-RS ports or resources) associated with signal path 405-a may be spatially and temporally precoded, and may each be associated with a respective, observed Doppler spectrum segment 410. The observed Doppler spectrum segment 410 may be within or between a lowest Doppler shift 420-a and a highest Doppler shift 420-b, which may represent a center frequency minus or plus a maximum Doppler shift.

As illustrated by FIG. 4B, a first CSI-RS port or resource associated with a signal path 405-b may be spatially and temporally precoded to follow a beam 430-c, which may mostly or fully correspond to a signal path 405-b. Similarly, one or more other CSI-RS ports or resources associated with signal path 405-b may be respectively spatially and temporally precoded up to a last CSI-RS port or resource associated with signal path 405-b. The last CSI-RS port or resource may, for example, be spatially and temporally precoded to follow a beam 430-d corresponding mostly or fully to signal path 405-b.

A signal (e.g., CSI-RS) carrying the first CSI-RS port or resource associated with signal path 405-b may be scattered by an object or other factor (e.g., or in some cases may not be scattered) and may reach and be received by UE 115-c. UE 115-c may observe a Doppler spectrum segment 415-c (e.g., having a center Doppler or average Doppler shift 425-c) associated with the first CSI-RS port or resource, which may correspond to a Doppler shift corresponding to signal path 405-b and beam 430-c. An observed Doppler spectrum segment 410-c associated with signal path 405-a may be minimized or eliminated, for example, based on the spatial precoding of the first CSI-RS port or resource.

A signal carrying the last CSI-RS port or resource associated with signal path 405-b may be scattered by an object or other factor (e.g., or in some cases may not be scattered) and may reach and be received by UE 115-c. UE 115-c may observe a Doppler spectrum segment 415-d (e.g., having a center Doppler or average Doppler shift 425-d) associated with the last CSI-RS port or resource, which may correspond to a Doppler shift corresponding to signal path 405-b and beam 430-d. An observed Doppler spectrum segment 410-d associated with signal path 405-a may be minimized or eliminated, for example, based on the spatial precoding of the last CSI-RS port or resource.

Similarly, any other CSI-RS (e.g., between the first and last CSI-RS ports or resources) associated with signal path 405-b may be spatially and temporally precoded, and may each be associated with a respective, observed Doppler spectrum segment 415. The observed Doppler spectrum segment 415 may be within or between the lowest Doppler shift 420-a and the highest Doppler shift 420-b, which may represent a center frequency minus or plus a maximum Doppler shift.

It is to be understood that the examples described herein may apply to any number of CSI-RSs transmitted via any number of signal paths 405 without departing from the scope of the present disclosure. For example, although FIGS. 4A and 4B illustrate two signal paths 405, any number of signal paths 405 may be used to transmit spatially and temporally precoded CSI-RSs to UE 115-c.

Based on receiving the spatially and temporally precoded CSI-RSs (e.g., CSI-RS ports or resources) via the respective signal paths 405, UE 115-c may calculate a respective average Doppler shift for each CSI-RS (e.g., for each CSI-RS port or each CSI-RS resource). For example, UE 115-c may calculate a respective mean Doppler shift (e.g., fₛ) for each CSI-RS, or may calculate and report a respective root-mean-square Doppler spread (e.g., fᵣms) for each CSI-RS. In some cases, UE 115-b may calculate a normalized version of fₛ, fᵣₘₛ, or both. For example, UE 115-b may divide fₛ, fᵣₘₛ, or both, by a maximum Doppler shift to normalize fₛ, fᵣₘₛ, or both.

Based on the determined average Doppler shifts for each CSI-RS, UE 115-c may, for each signal path 405 (e.g., for each CSI-RS port group, CSI-RS resource, or CSI-RS resource set), select and report an index of a CSI-RS port or a CSI-RS resource indicator (CRI) (e.g., associated with a CSI-RS resource) corresponding to a lowest average Doppler shift (e.g., a lowest absolute average Doppler shift, a shift closest to a center frequency). In other words, UE 115-c may select and report an index of a CSI-RS port or CRI corresponding to a lowest average Doppler shift (e.g., lowest absolute average Doppler shift) from among CSI-RS ports or resources sharing a same spatial precoding (e.g., wₙ). For example, for signal path 405-a, UE 115-c may select and report an index of a CSI-RS port or CRI corresponding to a lowest average Doppler shift. Additionally, for signal path 405-b, UE 115-c may select and report an index of a CSI-RS port or CRI corresponding to a lowest average Doppler shift. Reporting the respective lowest average Doppler shifts (e.g., lowest absolute average Doppler shifts) may support aligning the respective Doppler shifts to a center frequency and to each other (e.g., reducing a span or scope between the respective Doppler shifts and the center frequency, between the respective Doppler shifts).

As described with reference to FIG. 2, base station 105-c may use the reported indices or CRIs (e.g., the reported CSI-RSs) to spatially and temporally precode one or more subsequent CSI-RSs transmitted to UE 115-c. For example, base station 105-c may spatially and temporally precode the CSI-RS(s) using an equation such as Equation (4). Based on the one or more CSI-RSs, UE 115-c may perform PMI feedback (e.g., may transmit the PMI feedback to base station 105-c), and base station 105-c may use the PMI feedback to spatially and temporally precode one or more downlink transmissions to UE 115-c.

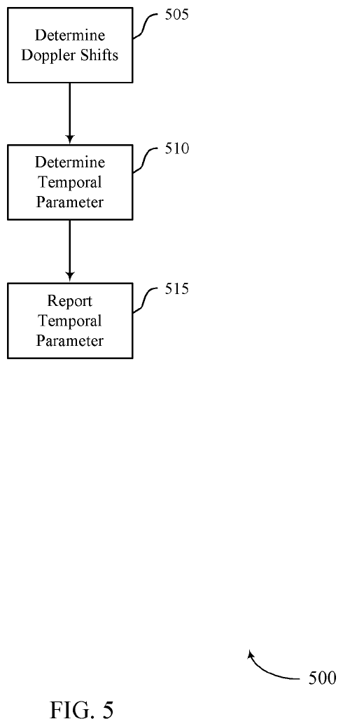

FIG. 5 illustrates an example of a flow diagram 500 that supports temporal and spatial precoding of downlink signals in accordance with aspects of the present disclosure. Some aspects of flow diagram 500 may implement or be implemented by wireless communications system 100 or 200. For example, flow diagram 500 may be implemented by a base station 105 and a UE 115, which may represent examples of a base station 105 and a UE 115 described with reference to FIGS. 1-4. As described with reference to FIG. 2, the base station 105 may spatially precode (e.g., or may not spatially precode) multiple CSI-RSs (e.g., with one or more CSI-RSs corresponding to a signal path or cluster) and transmit the spatially precoded (e.g., or non-spatially precoded) CSI-RSs to the UE 115. Based on the spatially precoded (e.g., or non-spatially precoded) CSI-RSs, the UE 115 may determine a respective mean or average Doppler shift for each CSI-RS (e.g., may determine an average across all of the rays of a CSI-RS associated with a respective signal path).

At 505, for example, the UE 115 may determine the average Doppler shift for each CSI-RS received from the base station 105. In some cases, the base station 105 may transmit one CSI-RS to the UE 115 via a respective signal path, and the average Doppler shift for the one CSI-RS may be representative of, or associated with, an average Doppler shift for the respective signal path. In some other cases, the base station 105 may transmit multiple CSI-RSs to the UE 115 via a respective signal path.

At 510, the UE 115 may use the determined average Doppler shifts to calculate a respective temporal parameter for PMI (e.g., a PMI based on temporal and spatial information) for each transmission layer. A number of transmission layers (e.g., a rank of a channel) may be jointly determined, or based on, a number of signal paths (e.g., clusters) and a correlation among the signal paths. For each transmission layer, the UE 115 may determine a respective spatial parameter and temporal parameter for a respective precoder.

For example, the UE 115 may determine a spatial domain basis parameter (e.g., B), a temporal domain basis parameter (e.g., Wₗ), and one or more other parameters (e.g., one or more coefficient vectors c, a frequency domain basis parameter W_{DFT}). The temporal parameter for the precoder may be given by an equation such as Equation (6):

$${W}_{l} = diag ( {e}^{- j 2 π {f}_{1} {lT}_{sym}} , {e}^{- j 2 π {f}_{2} {lT}_{sym}} , … , {e}^{- j 2 π {f}_{L} {lT}_{sym}} ) \qquad ( 6 )$$

where Wₗ represents the temporal parameter, l represents a symbol index (e.g., an index of an OFDM symbol), diag represents a diagonal matrix operation, fₙ represents an average Doppler shift for the nth CSI-RS (e.g., which variable ranges from 1 to L, or an Lth CSI-RS), and T_{sym} represents a symbol length (e.g., an OFDM symbol length).

At 515, the UE 115 may report the precoder parameters (e.g., the PMI) for each transmission layer to the base station. For example, the UE may report the temporal parameter, Wₗ, along with one or more other parameters (e.g., B, W_{DFT}, c vectors). The base station 105 may use the reported parameters to spatially and temporally precode one or more downlink transmission layers to the UE 115. In a first example, the base station 105 may precode a respective signal of the one or more downlink transmission layers using a precoder given by an equation such as Equation (7):

$${w}_{r , k , l} = {I}_{2} ⊗ ( B {W}_{l} ) [ \begin{matrix}{c}_{r , k , 1} \\ {c}_{r , k , 2}\end{matrix} ] \qquad ( 7 )$$

where w_{r,k,l} represents a precoder for an rth layer and kth sub-band, l represents a symbol (e.g., OFDM symbol) index, I₂ represents an identity matrix of size 2, B represents a spatial domain basis reported by the UE 115, Wₗ represents the temporal parameter (e.g., temporal domain basis) reported by the UE 115 (e.g., as given by Equation (6)), c_{r,k,1} represents a first coefficient vector reported by the UE 115, and c_{r,k,2} represents a second coefficient vector reported by the UE 115. For example, the aforementioned first coefficient vector c_{r,k,1} and second coefficient vector c_{r,k,2} may correspond with two polarizations, respectively (e.g., each coefficient vector corresponding with a respective polarization).

In a second example, the base station 105 may precode a respective signal of the one or more downlink transmission layers using a precoder given by an equation such as Equation (8):

$$[ {w}_{r , 1 , l} , {w}_{r , 2 , l} , … , {w}_{r , {N}_{3} , l} ] = {I}_{2} ⊗ ( B {W}_{l} ) [ \begin{matrix}{c}_{r , 1 , 1} & {c}_{r , 2 , 1} & … & {c}_{r , {M}_{v} , 1} \\ {c}_{r , 1 , 2} & {c}_{r , 2 , 2} & … & {c}_{r , {M}_{v} , 2}\end{matrix} ] {W}_{DFT}^{H} \qquad ( 8 )$$

where w_{r,k,l} represents a precoder for an rth layer and kth sub-band group (e.g., where k goes from 1 to N₃), l represents a symbol (e.g., OFDM symbol) index, I₂ represents an identity matrix of size 2, B represents a spatial domain basis reported by the UE 115, Wₗ represents the temporal parameter (e.g., temporal domain basis) reported by the UE 115 (e.g., as given by Equation (6)), [c_{r,1,1} c_{r,2,1} . . . c_{r,M}_{ᵥ}_{,1}] represents a first set of coefficient vectors reported by the UE 115, [c_{r,1,2} c_{r,2,2} . . . c_{r,M}_{ᵥ}_{,2}] represents a second set of coefficient vectors reported by the UE 115 (e.g., the aforementioned first set of coefficient vectors [c_{r,1,1} c_{r,2,1} . . . c_{r,M}_{ᵥ}_{,1}] and second set of coefficient vectors [c_{r,1,2} c_{r,2,2} . . . c_{r,M}_{ᵥ}_{,2}] may correspond with two polarizations, respectively, with one, respective polarization corresponding with each set of vectors), and W_{DFT}^{H} represents a frequency domain basis reported by the UE 115.

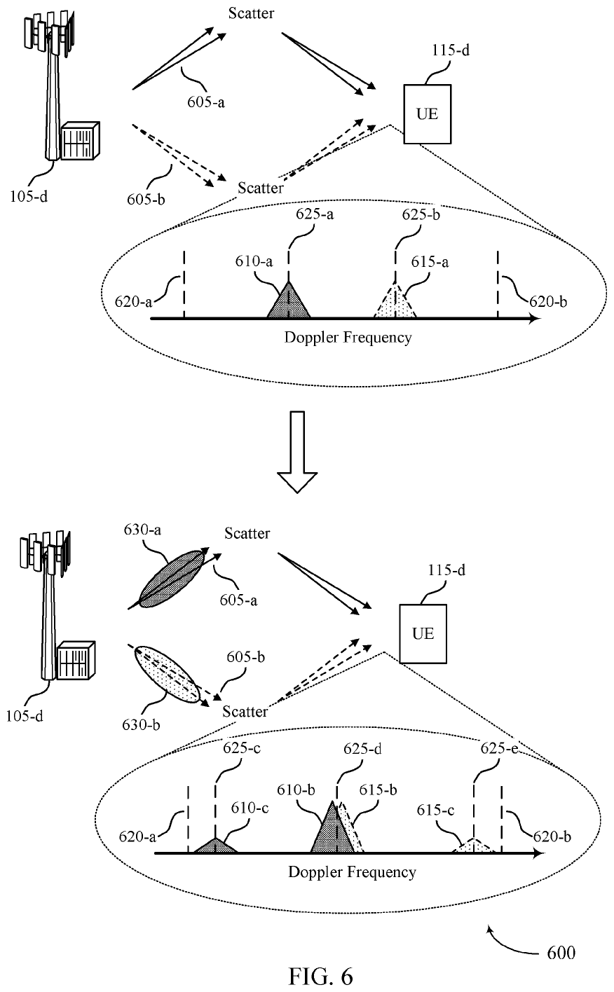

FIG. 6 illustrates an example of a wireless communications system 600 that supports temporal and spatial precoding of downlink signals in accordance with aspects of the present disclosure. Some aspects of wireless communications system 600 may implement or be implemented by wireless communications system 100 or 200. For example, wireless communications system 600 may include a base station 105-d and a UE 115-d, which may represent examples of a base station 105 and a UE 115 described with reference to FIGS. 1-5. As described with reference to FIG. 2, base station 105-d may communicate one or more downlink transmissions (e.g., CSI-RS(s)) to UE 115-d via multiple signal paths 605, via multiple beams, or both. For example, base station 105-d may transmit a downlink transmission at least partially concurrently via a first signal path 605-a in (e.g., or close to) a first direction (e.g., which may reflect or scatter, or may not scatter) and a second signal path 605-b in (e.g., or close to) a second direction (e.g., which may also reflect or scatter, or may not scatter). The downlink transmission, may, for example, have a strong selectivity in the time domain due to Doppler shifts in the different signal paths 605 (e.g., based on a movement of UE 115-d). In some cases, base station 105-d may communicate one or more downlink transmissions (e.g., CSI-RS(s)) to UE 115-d via one signal path 605, one beam, or both, which may also experience a strong (e.g., relatively higher) selectivity in the time domain due to Doppler shifting.

In one example, a signal (e.g., CSI-RS) carrying the downlink transmission via signal path 605-a may be scattered by an object or other factor (e.g., or in some cases may not be scattered) and may reach and be received by UE 115-d. UE 115-d may observe a Doppler spectrum segment 610-a (e.g., having a center Doppler or average Doppler shift 625-a) associated with signal path 605-a. A signal (e.g., CSI-RS) carrying the downlink transmission via signal path 605-b may be scattered by an object or other factor (e.g., or in some cases may not be scattered) and may reach and be received by UE 115-d. UE 115-d may observe a Doppler spectrum segment 615-a (e.g., having a center Doppler or average Doppler shift 625-b) associated with signal path 605-b. The observed Doppler spectrum segment 610 and 615 may be within or between a lowest Doppler shift 620-a and a highest Doppler shift 620-b, which may represent a center frequency 625-d minus or plus a maximum Doppler shift.

As described herein, base station 105-d may reduce or eliminate a respective Doppler spectrum segment 610 or 615 (e.g., reduce selectivity in the time domain) associated with the downlink transmission transmitted via signal path 605-a, 605-b, or both (e.g., among other signal paths 605) based on spatially and temporally precoding the downlink transmission. For example, base station 105-d may spatially and temporally precode the downlink transmission based on feedback received from UE 115-d, where the feedback may be based on previously transmitted spatially and temporally precoded (e.g., or temporally precoded, or non-precoded) CSI-RSs (e.g., as described with reference to FIGS. 3A-3B and 4A-4B). Additionally or alternatively, base station 105-d may spatially and temporally precode the downlink transmission based on PMI reported by UE 115-d (e.g., including a temporal parameter, as described with reference to FIG. 5).

The spatial and temporal precoding for signal path 605-a or 605-b may be represented by a beam 630-a or a beam 630-b, respectively. Based on the spatial and temporal precoding, Doppler spectrum segment 610-b, 615-b, or both, may align (e.g., substantially align) at a center frequency 625-d or reduce in span or scope about the center frequency 625-d (e.g., based on using a temporal and spatial precoder that accounts for respective Doppler shifts, such as described herein with reference to FIGS. 3A and 3B or FIG. 5). Smaller, or lower-powered, components of a respective signal transmitted via signal path 605-a, 605-b, or both, may be observed as a Doppler spectrum segment 610-c (e.g., having a center Doppler or average Doppler shift 625-c) or a Doppler spectrum segment 615-c (e.g., having a center Doppler or average Doppler shift 625-e), respectively.

Doppler spectrum segment 610-c, 615-c, or both, in some cases, may have a sufficiently low received power at UE 115-d and may not affect (e.g., not largely affect, not affect so much) an observed or processed downlink transmission at UE 115-d. As described herein, the spatially and temporally precoded downlink transmission may include CSI-RSs, demodulation reference signals (DMRSs), one or more other reference signals, a downlink control channel (e.g., physical downlink control channel (PDCCH)), a downlink shared channel (e.g., a physical downlink shared channel (PDSCH)), or any combination thereof.

Based on the spatially and temporally precoded downlink transmission, UE 115-d may receive and detect the data (e.g., or other information) transmitted by base station 105-d (e.g., using a legacy or existing data detection method). Based on the spatially and temporal precoding, the downlink transmission may have a relatively lower selectivity in the time domain, associated CSI may become outdated over a longer time duration, and communication quality may increase at UE 115-d (e.g., based on usage of less overhead, a lower CSI reporting rate, a higher quality of communications based on reported CSI).

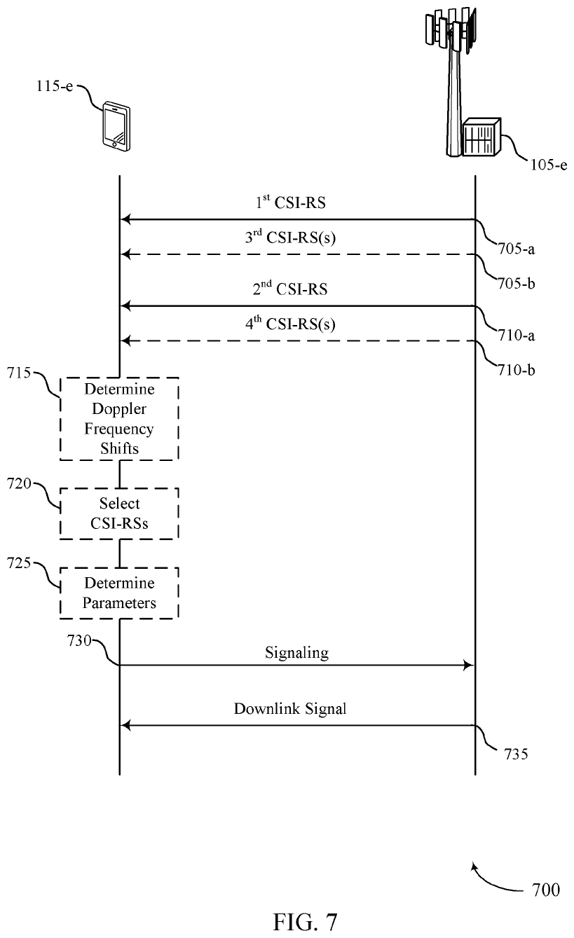

FIG. 7 illustrates an example of a process flow 700 that supports temporal and spatial precoding of downlink signals in accordance with aspects of the present disclosure. In some examples, process flow 700 may be implemented by aspects of wireless communications system 100 or 200, as well as aspects of wireless communications systems 301 and 302, wireless communications systems 401 and 402, flow diagram 500, and/or wireless communications system 600. For example, process flow 700 may be implemented by a base station 105-e and a UE 115-e, which may be examples of a base station 105 and UEs 115 as described with reference to FIGS. 1-6.

In the following description of the process flow 700, the operations between base station 105-e and UE 115-e may be transmitted or performed in a different order than the order shown. Some operations may also be left out of the process flow 700, or other operations may be added to the process flow 700. It is to be understood that while base station 105-e and UE 115-e are shown performing the operations of process flow 700, any wireless device may perform the operations shown.

At 705-a, base station 105-e may transmit, to UE 115-e, a first CSI-RS via a first signal path (e.g., a first cluster, such as a cluster of rays), where the first CSI-RS may be spatially precoded (e.g., at least spatially precoded) based on a prior communication between UE 115-e and base station 105-e. In some cases, the first CSI-RS may not be spatially precoded. In a first example (e.g., described with reference to FIGS. 3A and 3B), the first CSI-RS may be spatially precoded (e.g., or non-precoded), such that the first CSI-RS may be received partially or completely via the first signal path (e.g., may correspond to the first signal path). In a second example (e.g., consistent with FIGS. 4A and 4B), the first CSI-RS may be spatially precoded and temporally precoded (e.g., or temporally precoded but not spatially precoded), such that the first CSI-RS may correspond to the first signal path and may also correspond to a first, respective Doppler spectrum segment.

At 705-b, in the second example, base station 105-e may transmit, to UE 115-e and (e.g., mainly) via the first signal path, one or more third CSI-RSs that are spatially and temporally precoded (e.g., or that are temporally precoded but not spatially precoded). For example, the one or more third CSI-RSs may each correspond to the first signal path based on a shared or similar spatial precoding (e.g., which may also be shared with the first CSI-RS) and may each correspond to a respective Doppler shift based on their respective temporal precoding. The first CSI-RS and the one or more third CSI-RSs may be included in a first set of CSI-RSs that may have a same spatial precoding (e.g., to correspond to the first signal path), but may each have a different, respective temporal precoding.

At 710-a, base station 105-e may transmit, to UE 115-e, a second CSI-RS (e.g., mainly) via a second signal path (e.g., a second cluster, such as a cluster of rays), where the second CSI-RS may be spatially precoded (e.g., at least spatially precoded) based on a prior communication between UE 115-e and base station 105-e. In some cases, the second CSI-RS may not be spatially precoded. In a first example (e.g., described with reference to FIGS. 3A and 3B), the second CSI-RS may be spatially precoded (e.g., or non-precoded), such that the second CSI-RS may be received partially or completely via the second signal path (e.g., may correspond to the second signal path). In a second example (e.g., described with reference to FIGS. 4A and 4B), the second CSI-RS may be spatially precoded and temporally precoded (e.g., or not spatially precoded but temporally precoded), such that the second CSI-RS may correspond to the second signal path and may also correspond to a second, respective Doppler shift.

At 710-b, in the second example, base station 105-e may transmit, to UE 115-e and (e.g., mainly) via the second signal path, one or more fourth CSI-RSs that are spatially and temporally precoded (e.g., temporally precoded). For example, the one or more fourth CSI-RSs may each correspond to the second signal path based on a shared or similar spatial precoding (e.g., which may also be shared with the second CSI-RS) and may each correspond to a respective Doppler shift based on their respective temporal precoding. The second CSI-RS and the one or more fourth CSI-RSs may be included in a second set of CSI-RSs that may have a same spatial precoding (e.g., to correspond to the second signal path), but may each have a different, respective temporal precoding.

At 715, in some cases, UE 115-e may determine a respective, average Doppler frequency shift (e.g., mean Doppler shift, root-mean-square Doppler shift, normalized versions thereof) for each received CSI-RS. As such, in the first example, UE 115-e may determine a respective, average Doppler frequency shift for the first CSI-RS (e.g., corresponding to the first signal path) and for the second CSI-RS (e.g., corresponding to the second signal path). In the second example, UE 115-e may determine a respective, average Doppler frequency shift for the first CSI-RS and for each of the third CSI-RS(s) (e.g., corresponding to the first signal path and to different temporal precodings), as well as a respective, average Doppler frequency shift for the second CSI-RS and for each of the fourth CSI-RS(s) (e.g., corresponding to the second signal path and to different temporal precodings).

At 720, in the second example, UE 115-e may select a CSI-RS having a lowest average Doppler frequency shift from the first set of CSI-RSs and may select a CSI-RS having a lowest average Doppler frequency shift from the second set of CSI-RSs. Selecting the CSI-RSs from the respective sets of CSI-RSs having the lowest, respective average Doppler frequency shift may be based, for example, on determining the Doppler frequency shifts at 715.

At 725, in a third example, UE 115-e may determine multiple parameters for a spatial and temporal precoder (e.g., may determine PMI to report to base station 105-e), as described with reference to FIG. 5. For example, UE 115-e may determine a respective, average Doppler frequency shift for the first CSI-RS and the second CSI-RS (e.g., among other CSI-RSs), such as at 715. Based on the respective, average Doppler frequency shifts, UE 115-e may determine a first temporal parameter to report to base station 105-e for the first signal path and a second temporal parameter to report to base station 105-e for the second signal path. UE 115-e may also determine a spatial parameter to report to base station 105-e based on the first and second CSI-RSs.

At 730, UE 115-e may transmit, to base station 105-e, signaling indicative of (e.g., an indication of) a first Doppler frequency shift and a second Doppler frequency shift. The first Doppler frequency shift may be based on an average of a first set of multiple Doppler frequency shifts associated with the first CSI-RS, and the second Doppler frequency shift may be based on an average of a second set of multiple Doppler frequency shifts associated with the second CSI-RS. In the first example, the signaling indicative of (e.g., the indication of) the first and second Doppler frequency shifts may include an indication of a determined, first average Doppler frequency shift associated with the first CSI-RS and a determined, second average Doppler frequency shift associated with the second CSI-RS.

In the second example, the signaling indicative of (e.g., the indication of) the first and second Doppler frequency shifts may include an indication of the CSI-RS selected from the first set of CSI-RSs and the CSI-RS selected from the second set of CSI-RSs, respectively (e.g., based on the first Doppler shift being the lowest average Doppler shift for the first set of CSI-RSs and the second Doppler shift being the lowest average Doppler shift for the second set of CSI-RSs). In the third example, the signaling indicative of (e.g., the indication of) the first Doppler frequency shift may include an indication of the first temporal parameter and the second temporal parameter, for example, as determined at 725.

At 735, base station 105-e may transmit, to UE 115-e, a downlink signal communicated (e.g., mainly) via the first signal path, the second signal path, or both. The downlink signal may be communicated (e.g., mainly) via the first signal path using first temporal and spatial precoding (e.g., a first temporal and spatial precoder) and/or (e.g., mainly) via the second signal path using second temporal and spatial precoding (e.g., a second temporal and spatial precoder). The first temporal and spatial precoding may be based on the indication of the first Doppler frequency shift, and the second temporal and spatial precoding may be based on the indication of the second Doppler frequency shift. In some cases (e.g., in the first and second examples), as described with reference to FIGS. 3A-3B and 4A-4B, the respective temporal and spatial precodings may be based on respective CSI reported by UE 115-e to base station 105-e, where the CSI may be based on CSI-RSs that are temporally and spatially precoded by base station 105-e using the indication of the first Doppler frequency shift and the second Doppler frequency shift.

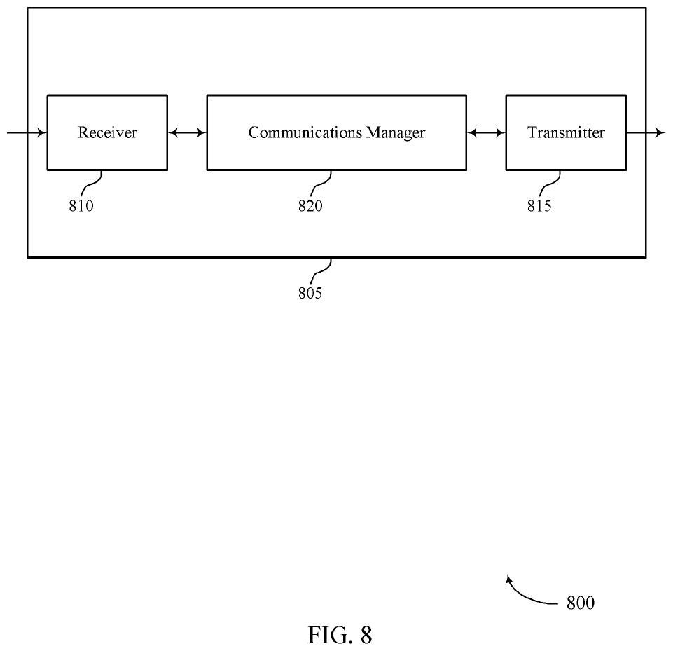

FIG. 8 shows a block diagram 800 of a device 805 that supports temporal and spatial precoding of downlink signals in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to temporal and spatial precoding of downlink signals). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to temporal and spatial precoding of downlink signals). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of temporal and spatial precoding of downlink signals as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a UE in accordance with examples as disclosed herein. For example, the communications manager 820 may be configured as or otherwise support a means for receiving, from a base station, a first CSI-RS via a first signal path and a second CSI-RS via a second signal path, where the first CSI-RS and the second CSI-RS are each spatially precoded based on a prior communication with the base station. The communications manager 820 may be configured as or otherwise support a means for transmitting, to the base station and based on receiving the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS. The communications manager 820 may be configured as or otherwise support a means for receiving, from the base station, a downlink signal communicated via the first signal path using first temporal and spatial precoding and communicated via the second signal path using second temporal and spatial precoding, the first temporal and spatial precoding and the second temporal and spatial precoding based on the indication of the first Doppler frequency shift and the second Doppler frequency shift.

The actions performed by the communications manager 820, among other examples herein, may be implemented to realize one or more potential advantages. For example, communications manager 820 may increase available battery power, communication quality, and communication reliability at a wireless device (e.g., a UE 115) by supporting transmission of spatially and temporally precoded downlink signals via multiple signal paths, which may increase communication quality at the wireless device by decreasing a time domain selectivity of the downlink signals. The associated increase in communication quality may result in increased link performance and decreased overhead based on the spatial and temporal precoding. Accordingly, communications manager 820 may save power and increase battery life at a wireless device (e.g., a UE 115) by strategically increasing a quality of communications at a wireless device (e.g., a UE 115).

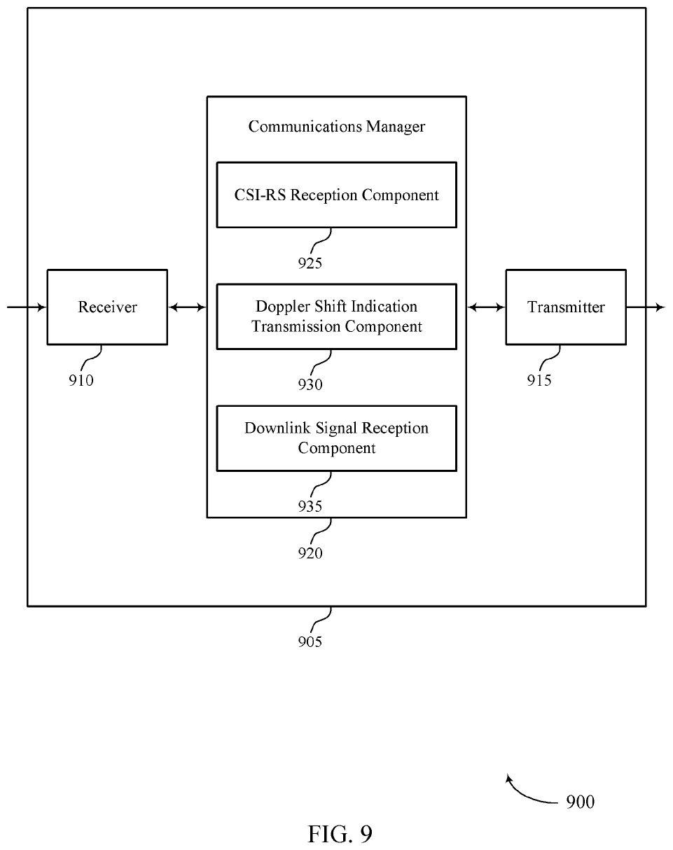

FIG. 9 shows a block diagram 900 of a device 905 that supports temporal and spatial precoding of downlink signals in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to temporal and spatial precoding of downlink signals). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to temporal and spatial precoding of downlink signals). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of temporal and spatial precoding of downlink signals as described herein. For example, the communications manager 920 may include a CSI-RS reception component 925, a Doppler shift indication transmission component 930, a downlink signal reception component 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a UE in accordance with examples as disclosed herein. The CSI-RS reception component 925 may be configured as or otherwise support a means for receiving, from a base station, a first CSI-RS via a first signal path and a second CSI-RS via a second signal path, where the first CSI-RS and the second CSI-RS are each spatially precoded based on a prior communication with the base station. The Doppler shift indication transmission component 930 may be configured as or otherwise support a means for transmitting, to the base station and based on receiving the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS. The downlink signal reception component 935 may be configured as or otherwise support a means for receiving, from the base station, a downlink signal communicated via the first signal path using first temporal and spatial precoding and communicated via the second signal path using second temporal and spatial precoding, the first temporal and spatial precoding and the second temporal and spatial precoding based on the indication of the first Doppler frequency shift and the second Doppler frequency shift.

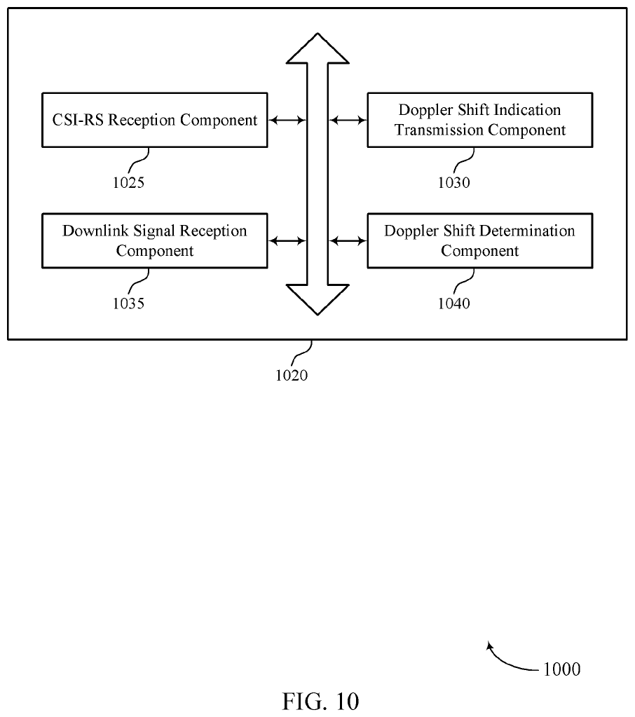

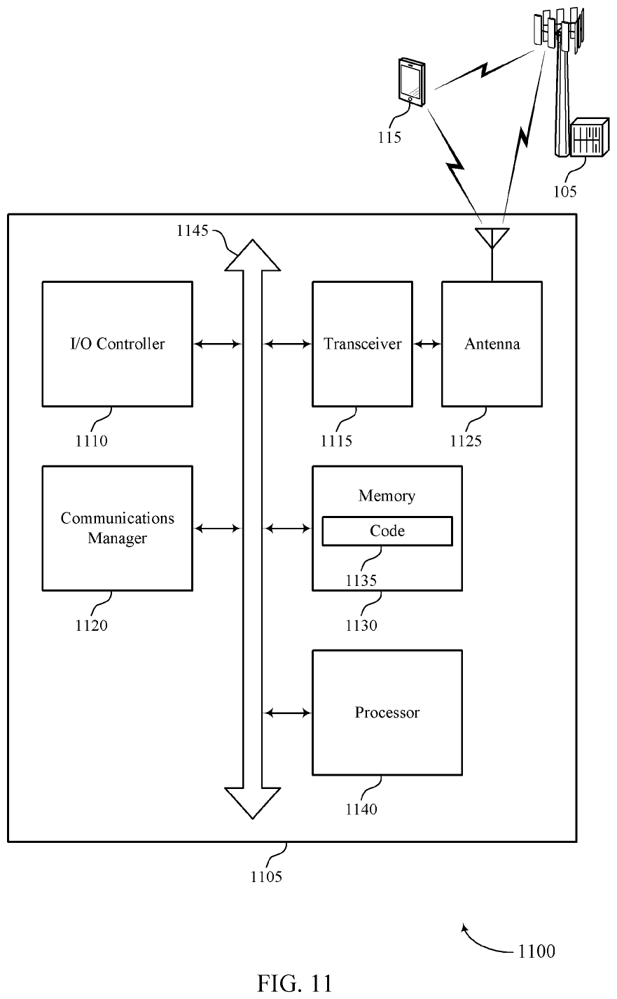

A processor of a wireless device (e.g., controlling the receiver 910, the transmitter 915, or the transceiver 1115 as described with reference to FIG. 11) may increase available battery power and communication quality. The increased communication quality may increase available battery power and throughput (e.g., via implementation of system components described with reference to FIG. 10) compared to other systems and techniques, for example, that do not support transmission of spatially and temporally precoded downlink signals via multiple signal paths. Further, the processor of the wireless device may identify one or more aspects of the spatially and temporally precoded signals, which may result in increased communication quality, as well as save power and increase battery life at the wireless device (e.g., by strategically supporting increased transmission diversity and quality), among other benefits.

FIG. 10 shows a block diagram 1000 of a communications manager 1020 that supports temporal and spatial precoding of downlink signals in accordance with aspects of the present disclosure. The communications manager 1020 may be an example of aspects of a communications manager 820, a communications manager 920, or both, as described herein. The communications manager 1020, or various components thereof, may be an example of means for performing various aspects of temporal and spatial precoding of downlink signals as described herein. For example, the communications manager 1020 may include a CSI-RS reception component 1025, a Doppler shift indication transmission component 1030, a downlink signal reception component 1035, a Doppler shift determination component 1040, or any combination thereof. Each of these components may communicate, directly or indirectly, with one another (e.g., via one or more buses).

The communications manager 1020 may support wireless communication at a UE in accordance with examples as disclosed herein. The CSI-RS reception component 1025 may be configured as or otherwise support a means for receiving, from a base station, a first CSI-RS via a first signal path and a second CSI-RS via a second signal path, where the first CSI-RS and the second CSI-RS are each spatially precoded based on a prior communication with the base station. The Doppler shift indication transmission component 1030 may be configured as or otherwise support a means for transmitting, to the base station and based on receiving the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS. The downlink signal reception component 1035 may be configured as or otherwise support a means for receiving, from the base station, a downlink signal communicated via the first signal path using first temporal and spatial precoding and communicated via the second signal path using second temporal and spatial precoding, the first temporal and spatial precoding and the second temporal and spatial precoding based on the indication of the first Doppler frequency shift and the second Doppler frequency shift.

In some examples, the Doppler shift determination component 1040 may be configured as or otherwise support a means for determining the first Doppler frequency shift based on receiving the first CSI-RS, where the signaling indicative of the first Doppler frequency shift includes an indication of the determined first Doppler frequency shift. In some examples, the Doppler shift determination component 1040 may be configured as or otherwise support a means for determining the second Doppler frequency shift based on receiving the second CSI-RS, where the signaling indicative of the second Doppler frequency shift includes an indication of the determined second Doppler frequency shift.

In some examples, the first Doppler frequency shift includes the average of the first set of multiple Doppler frequency shifts divided by a Doppler frequency shift. In some examples, the second Doppler frequency shift includes the average of the second set of multiple Doppler frequency shifts divided by the Doppler frequency shift.

In some examples, the first CSI-RS corresponds to a first CSI-RS port, the second CSI-RS corresponds to a second CSI-RS port, and the first CSI-RS port and the second CSI-RS port correspond to a same CSI-RS port group or CSI-RS resource. In some examples, the first CSI-RS corresponds to a first CSI-RS resource, the second CSI-RS corresponds to a second CSI-RS resource, and the first CSI-RS resource and the second CSI-RS resource correspond to a same CSI-RS resource set.

In some examples, the first CSI-RS and the second CSI-RS are each temporally precoded, and the CSI-RS reception component 1025 may be configured as or otherwise support a means for receiving, via the first signal path, one or more third CSI-RSs that are spatially and temporally precoded. In some examples, the first CSI-RS and the second CSI-RS are each temporally precoded, and the CSI-RS reception component 1025 may be configured as or otherwise support a means for receiving, via the second signal path, one or more fourth CSI-RSs that are spatially and temporally precoded.

In some examples, the first CSI-RS and the second CSI-RS are each temporally precoded, and the Doppler shift determination component 1040 may be configured as or otherwise support a means for selecting a CSI-RS having a lowest average Doppler frequency shift from a first set of CSI-RSs that includes the first CSI-RS and the one or more third CSI-RSs, where the signaling indicative of the first Doppler frequency shift includes an indication of the CSI-RS selected from the first set of CSI-RSs, and where the first Doppler frequency shift includes the lowest average Doppler frequency shift associated with the first set of CSI-RSs.

In some examples, the first CSI-RS and the second CSI-RS are each temporally precoded, and the Doppler shift determination component 1040 may be configured as or otherwise support a means for selecting a CSI-RS having a lowest average Doppler frequency shift from a second set of CSI-RSs that includes the second CSI-RS and the one or more fourth CSI-RSs, where the signaling indicative of the second Doppler frequency shift includes an indication of the CSI-RS selected from the second set of CSI-RSs, and where the second Doppler frequency shift includes the lowest average Doppler frequency shift associated with the second set of CSI-RSs.

In some examples, each CSI-RS of the first set of CSI-RSs is spatially precoded using a first spatial precoding, each CSI-RS of the second set of CSI-RSs is spatially precoded using a second spatial precoding, each CSI-RS of the first set of CSI-RSs is temporally precoded using different temporal precoding, and each CSI-RS of the second set of CSI-RSs is temporally precoded using different temporal precoding.

In some examples, the first CSI-RS corresponds to a first CSI-RS port, the one or more third CSI-RSs each correspond to a respective third CSI-RS port, the first CSI-RS port and the one or more third CSI-RS ports correspond to a first CSI-RS port group or a first CSI-RS resource, the second CSI-RS corresponds to a second CSI-RS port, the one or more fourth CSI-RSs each correspond to a respective fourth CSI-RS port, and the second CSI-RS port and the one or more fourth CSI-RS ports correspond to a second CSI-RS port group or a second CSI-RS resource. In some examples, the first CSI-RS corresponds to a first CSI-RS resource, the one or more third CSI-RSs each correspond to a respective third CSI-RS resource, the first CSI-RS resource and the one or more third CSI-RS resources correspond to a first CSI-RS resource set, the second CSI-RS corresponds to a second CSI-RS resource, the one or more fourth CSI-RSs each correspond to a respective fourth CSI-RS resource, and the second CSI-RS resource and the one or more fourth CSI-RS resources correspond to a second CSI-RS resource set.

In some examples, the Doppler shift determination component 1040 may be configured as or otherwise support a means for determining a first temporal parameter for a first precoder associated with the first CSI-RS based on the first Doppler frequency shift for the first CSI-RS, where the signaling indicative of the first Doppler frequency shift includes an indication of the first temporal parameter for the first precoder. In some examples, the Doppler shift determination component 1040 may be configured as or otherwise support a means for determining a second temporal parameter for a second precoder associated with the second CSI-RS based on the second Doppler frequency shift for the second CSI-RS, where the signaling indicative of the second Doppler frequency shift includes an indication of the second temporal parameter for the second precoder.

In some examples, the first temporal and spatial precoding for the downlink signal uses the first precoder and the first temporal parameter. In some examples, the second temporal and spatial precoding for the downlink signal uses the second precoder and the second temporal parameter. In some examples, the downlink signal includes a CSI-RS, a demodulation reference signal, a downlink control channel, a downlink shared channel, or any combination thereof.

FIG. 11 shows a diagram of a system 1100 including a device 1105 that supports temporal and spatial precoding of downlink signals in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting temporal and spatial precoding of downlink signals). For example, the device 1105 or a component of the device 1105 may include a processor 1140 and memory 1130 coupled to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for receiving, from a base station, a first CSI-RS via a first signal path and a second CSI-RS via a second signal path, where the first CSI-RS and the second CSI-RS are each spatially precoded based on a prior communication with the base station. The communications manager 1120 may be configured as or otherwise support a means for transmitting, to the base station and based on receiving the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS. The communications manager 1120 may be configured as or otherwise support a means for receiving, from the base station, a downlink signal communicated via the first signal path using first temporal and spatial precoding and communicated via the second signal path using second temporal and spatial precoding, the first temporal and spatial precoding and the second temporal and spatial precoding based on the indication of the first Doppler frequency shift and the second Doppler frequency shift.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of temporal and spatial precoding of downlink signals as described herein, or the processor 1140 and the memory 1130 may be otherwise configured to perform or support such operations.

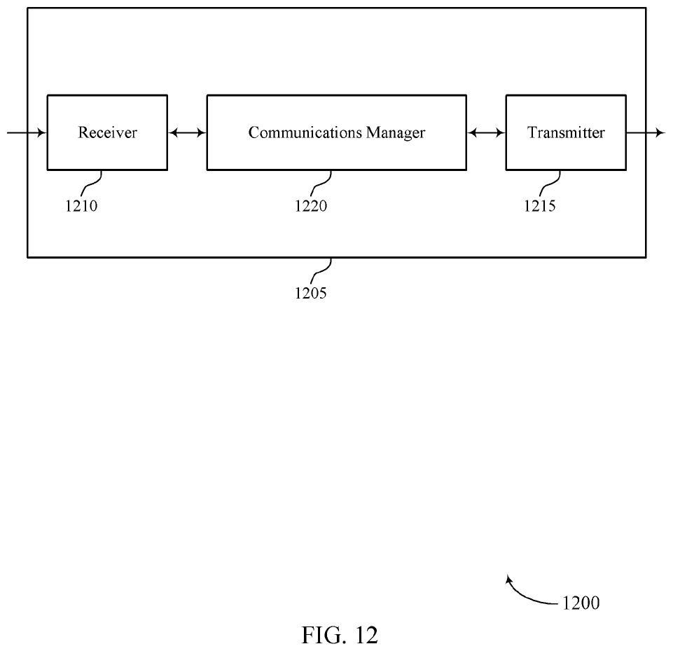

FIG. 12 shows a block diagram 1200 of a device 1205 that supports temporal and spatial precoding of downlink signals in accordance with aspects of the present disclosure. The device 1205 may be an example of aspects of a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to temporal and spatial precoding of downlink signals). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to temporal and spatial precoding of downlink signals). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of temporal and spatial precoding of downlink signals as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a base station in accordance with examples as disclosed herein. For example, the communications manager 1220 may be configured as or otherwise support a means for transmitting, to a UE, a first CSI-RS via a first signal path and a second CSI-RS via a second signal path, where the first CSI-RS and the second CSI-RS are each spatially precoded based on a prior communication with the UE. The communications manager 1220 may be configured as or otherwise support a means for receiving, from the UE and based on transmitting the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS. The communications manager 1220 may be configured as or otherwise support a means for transmitting, to the UE, a downlink signal communicated via the first signal path using first temporal and spatial precoding and communicated via the second signal path using second temporal and spatial precoding, the first temporal and spatial precoding and the second temporal and spatial precoding determined based on the indication of the first Doppler frequency shift and the second Doppler frequency shift.

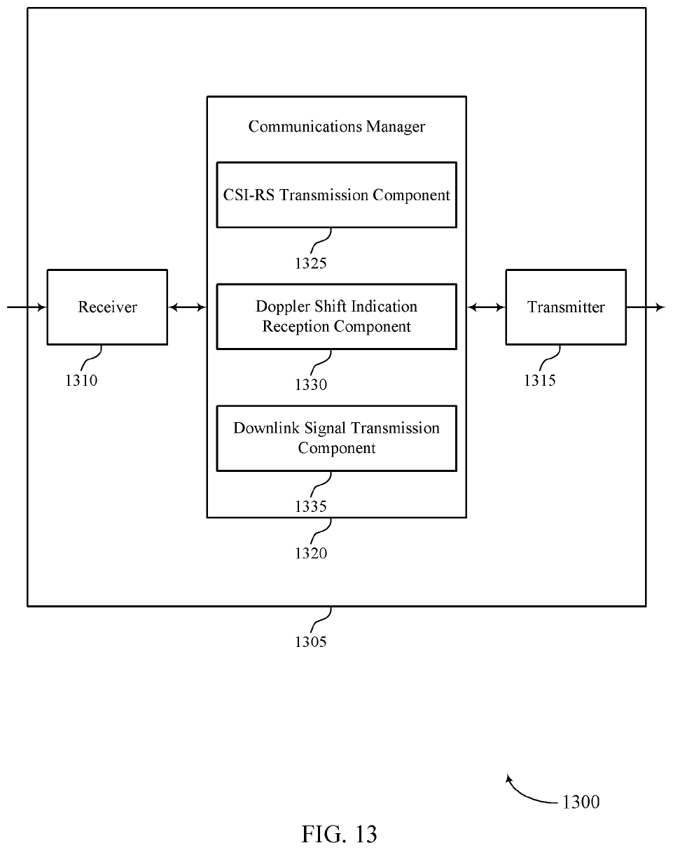

FIG. 13 shows a block diagram 1300 of a device 1305 that supports temporal and spatial precoding of downlink signals in accordance with aspects of the present disclosure. The device 1305 may be an example of aspects of a device 1205 or a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to temporal and spatial precoding of downlink signals). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to temporal and spatial precoding of downlink signals). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of temporal and spatial precoding of downlink signals as described herein. For example, the communications manager 1320 may include a CSI-RS transmission component 1325, a Doppler shift indication reception component 1330, a downlink signal transmission component 1335, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communication at a base station in accordance with examples as disclosed herein. The CSI-RS transmission component 1325 may be configured as or otherwise support a means for transmitting, to a UE, a first CSI-RS via a first signal path and a second CSI-RS via a second signal path, where the first CSI-RS and the second CSI-RS are each spatially precoded based on a prior communication with the UE. The Doppler shift indication reception component 1330 may be configured as or otherwise support a means for receiving, from the UE and based on transmitting the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS. The downlink signal transmission component 1335 may be configured as or otherwise support a means for transmitting, to the UE, a downlink signal communicated via the first signal path using first temporal and spatial precoding and communicated via the second signal path using second temporal and spatial precoding, the first temporal and spatial precoding and the second temporal and spatial precoding determined based on the indication of the first Doppler frequency shift and the second Doppler frequency shift.

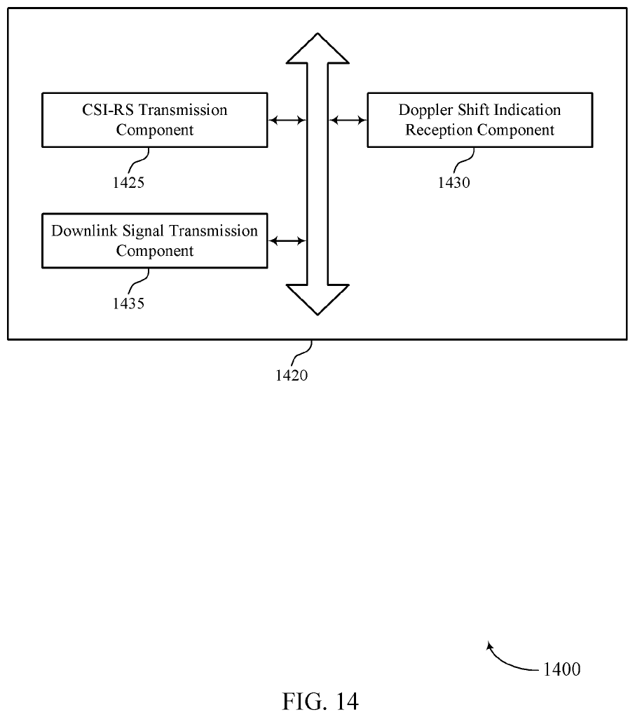

FIG. 14 shows a block diagram 1400 of a communications manager 1420 that supports temporal and spatial precoding of downlink signals in accordance with aspects of the present disclosure. The communications manager 1420 may be an example of aspects of a communications manager 1220, a communications manager 1320, or both, as described herein. The communications manager 1420, or various components thereof, may be an example of means for performing various aspects of temporal and spatial precoding of downlink signals as described herein. For example, the communications manager 1420 may include a CSI-RS transmission component 1425, a Doppler shift indication reception component 1430, a downlink signal transmission component 1435, or any combination thereof. Each of these components may communicate, directly or indirectly, with one another (e.g., via one or more buses).

The communications manager 1420 may support wireless communication at a base station in accordance with examples as disclosed herein. The CSI-RS transmission component 1425 may be configured as or otherwise support a means for transmitting, to a UE, a first CSI-RS via a first signal path and a second CSI-RS via a second signal path, where the first CSI-RS and the second CSI-RS are each spatially precoded based on a prior communication with the UE. The Doppler shift indication reception component 1430 may be configured as or otherwise support a means for receiving, from the UE and based on transmitting the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS. The downlink signal transmission component 1435 may be configured as or otherwise support a means for transmitting, to the UE, a downlink signal communicated via the first signal path using first temporal and spatial precoding and communicated via the second signal path using second temporal and spatial precoding, the first temporal and spatial precoding and the second temporal and spatial precoding determined based on the indication of the first Doppler frequency shift and the second Doppler frequency shift.

In some examples, to support receiving the signaling indicative of the first Doppler frequency shift and the second Doppler frequency shift, the Doppler shift indication reception component 1430 may be configured as or otherwise support a means for receiving an indication of the first Doppler frequency shift determined by the UE and an indication of the second Doppler frequency shift determined by the UE. In some examples, the first Doppler frequency shift includes the average of the first set of multiple Doppler frequency shifts divided by a Doppler frequency shift. In some examples, the second Doppler frequency shift includes the average of the second set of multiple Doppler frequency shifts divided by the Doppler frequency shift.

In some examples, the first CSI-RS corresponds to a first CSI-RS port, the second CSI-RS corresponds to a second CSI-RS port, and the first CSI-RS port and the second CSI-RS port correspond to a same CSI-RS port group or CSI-RS resource. In some examples, the first CSI-RS corresponds to a first CSI-RS resource, the second CSI-RS corresponds to a second CSI-RS resource, and the first CSI-RS resource and the second CSI-RS resource correspond to a same CSI-RS resource set.

In some examples, the first CSI-RS and the second CSI-RS are each temporally precoded, and the CSI-RS transmission component 1425 may be configured as or otherwise support a means for transmitting, via the first signal path, one or more third CSI-RSs that are spatially and temporally precoded. In some examples, the first CSI-RS and the second CSI-RS are each temporally precoded, and the CSI-RS transmission component 1425 may be configured as or otherwise support a means for transmitting, via the second signal path, one or more fourth CSI-RSs that are spatially and temporally precoded.

In some examples, to support receiving the signaling indicative of the first Doppler frequency shift and the second Doppler frequency shift, the Doppler shift indication reception component 1430 may be configured as or otherwise support a means for receiving an indication of a CSI-RS having a lowest average Doppler frequency shift selected from a first set of CSI-RSs that includes the first CSI-RS and the one or more third CSI-RSs, the first Doppler frequency shift including the lowest average Doppler frequency shift associated with the first set of CSI-RSs. In some examples, to support receiving the signaling indicative of the first Doppler frequency shift and the second Doppler frequency shift, the Doppler shift indication reception component 1430 may be configured as or otherwise support a means for receiving an indication of a CSI-RS having a lowest average Doppler frequency shift selected from a second set of CSI-RSs that includes the second CSI-RS and the one or more fourth CSI-RSs, the second Doppler frequency shift including the lowest average Doppler frequency shift associated with the second set of CSI-RSs.

In some examples, each CSI-RS of the first set of CSI-RSs is spatially precoded using a first spatial precoding, each CSI-RS of the second set of CSI-RSs is spatially precoded using a second spatial precoding, each CSI-RS of the first set of CSI-RSs is temporally precoded using different temporal precoding, and each CSI-RS of the second set of CSI-RSs is temporally precoded using different temporal precoding.

In some examples, the first CSI-RS corresponds to a first CSI-RS port, the one or more third CSI-RSs each correspond to a respective third CSI-RS port, the first CSI-RS port and the one or more third CSI-RS ports correspond to a first CSI-RS port group or a first CSI-RS resource, the second CSI-RS corresponds to a second CSI-RS port, the one or more fourth CSI-RSs each correspond to a respective fourth CSI-RS port, and the second CSI-RS port and the one or more fourth CSI-RS ports correspond to a second CSI-RS port group or a second CSI-RS resource. In some examples, the first CSI-RS corresponds to a first CSI-RS resource, the one or more third CSI-RSs each correspond to a respective third CSI-RS resource, the first CSI-RS resource and the one or more third CSI-RS resources correspond to a first CSI-RS resource set, the second CSI-RS corresponds to a second CSI-RS resource, the one or more fourth CSI-RSs each correspond to a respective fourth CSI-RS resource, and the second CSI-RS resource and the one or more fourth CSI-RS resources correspond to a second CSI-RS resource set.

In some examples, to support receiving the signaling indicative of the first Doppler frequency shift and the second Doppler frequency shift, the Doppler shift indication reception component 1430 may be configured as or otherwise support a means for receiving an indication of a first temporal parameter for a first precoder associated with the first CSI-RS, the first temporal parameter based on the first Doppler frequency shift for the first CSI-RS. In some examples, to support receiving the signaling indicative of the first Doppler frequency shift and the second Doppler frequency shift, the Doppler shift indication reception component 1430 may be configured as or otherwise support a means for receiving an indication of a second temporal parameter for a second precoder associated with the second CSI-RS, the second temporal parameter based on the second Doppler frequency shift for the second CSI-RS.

In some examples, the first temporal and spatial precoding for the downlink signal uses the first precoder and the first temporal parameter. In some examples, the second temporal and spatial precoding for the downlink signal uses the second precoder and the second temporal parameter. In some examples, the downlink signal includes a CSI-RS, a demodulation reference signal, a downlink control channel, a downlink shared channel, or any combination thereof.

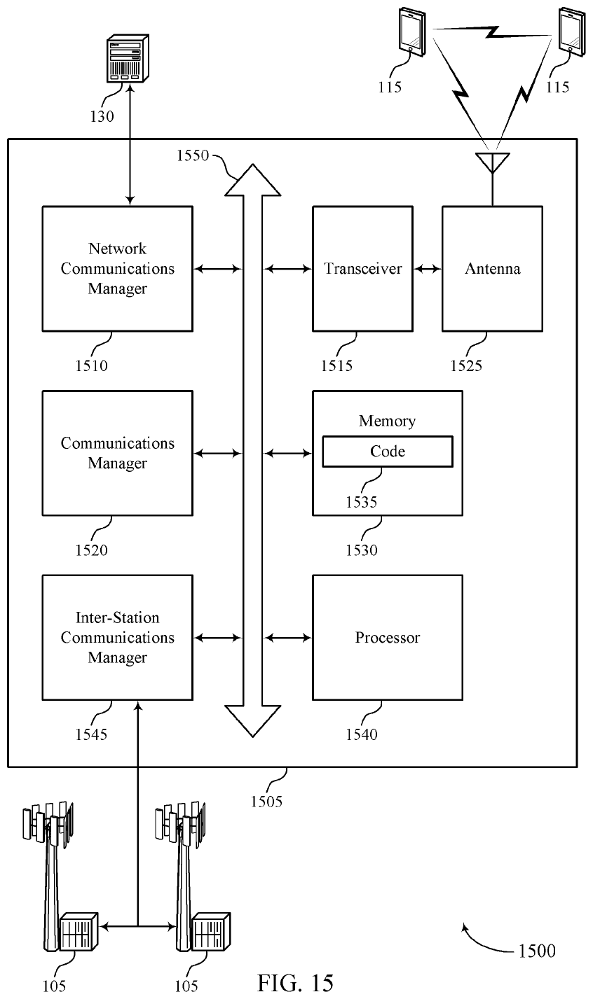

FIG. 15 shows a diagram of a system 1500 including a device 1505 that supports temporal and spatial precoding of downlink signals in accordance with aspects of the present disclosure. The device 1505 may be an example of or include the components of a device 1205, a device 1305, or a base station 105 as described herein. The device 1505 may communicate wirelessly with one or more base stations 105, UEs 115, or any combination thereof. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-station communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network 130 (e.g., via one or more wired backhaul links). For example, the network communications manager 1510 may manage the transfer of data communications for client devices, such as one or more UEs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a BIOS which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting temporal and spatial precoding of downlink signals). For example, the device 1505 or a component of the device 1505 may include a processor 1540 and memory 1530 coupled to the processor 1540, the processor 1540 and memory 1530 configured to perform various functions described herein.

The inter-station communications manager 1545 may manage communications with other base stations 105, and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communications network technology to provide communication between base stations 105.

The communications manager 1520 may support wireless communication at a base station in accordance with examples as disclosed herein. For example, the communications manager 1520 may be configured as or otherwise support a means for transmitting, to a UE, a first CSI-RS via a first signal path and a second CSI-RS via a second signal path, where the first CSI-RS and the second CSI-RS are each spatially precoded based on a prior communication with the UE. The communications manager 1520 may be configured as or otherwise support a means for receiving, from the UE and based on transmitting the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS. The communications manager 1520 may be configured as or otherwise support a means for transmitting, to the UE, a downlink signal communicated via the first signal path using first temporal and spatial precoding and communicated via the second signal path using second temporal and spatial precoding, the first temporal and spatial precoding and the second temporal and spatial precoding determined based on the indication of the first Doppler frequency shift and the second Doppler frequency shift.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of temporal and spatial precoding of downlink signals as described herein, or the processor 1540 and the memory 1530 may be otherwise configured to perform or support such operations.

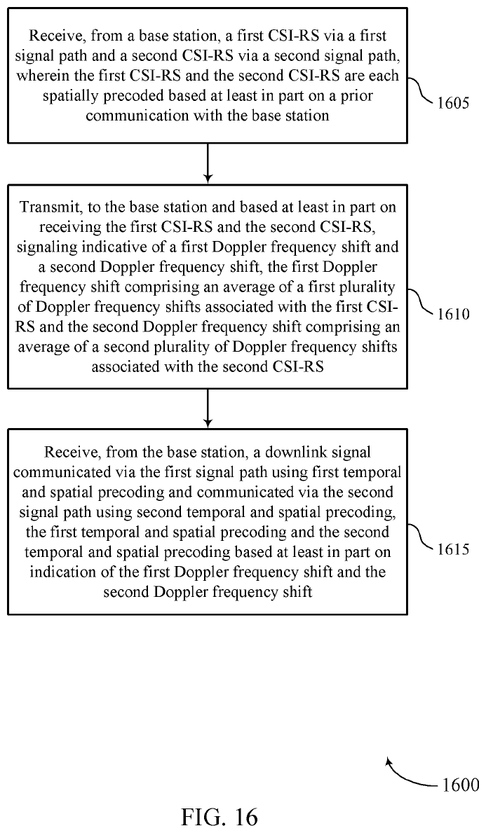

FIG. 16 shows a flowchart illustrating a method 1600 that supports temporal and spatial precoding of downlink signals in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1605, the method may include receiving, from a base station, a first CSI-RS via a first signal path and a second CSI-RS via a second signal path, where the first CSI-RS and the second CSI-RS are each spatially precoded based on a prior communication with the base station. The operations of 1605 may be performed in accordance with examples as disclosed herein. In some examples, aspects of the operations of 1605 may be performed by a CSI-RS reception component 1025 as described with reference to FIG. 10.

At 1610, the method may include transmitting, to the base station and based on receiving the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS. The operations of 1610 may be performed in accordance with examples as disclosed herein. In some examples, aspects of the operations of 1610 may be performed by a Doppler shift indication transmission component 1030 as described with reference to FIG. 10.

At 1615, the method may include receiving, from the base station, a downlink signal communicated via the first signal path using first temporal and spatial precoding and communicated via the second signal path using second temporal and spatial precoding, the first temporal and spatial precoding and the second temporal and spatial precoding based on the indication of the first Doppler frequency shift and the second Doppler frequency shift (e.g., the downlink signal may be a spatially and temporally precoded signal, such as one or more spatially and temporally precoded CSI-RSs). The operations of 1615 may be performed in accordance with examples as disclosed herein. In some examples, aspects of the operations of 1615 may be performed by a downlink signal reception component 1035 as described with reference to FIG. 10.

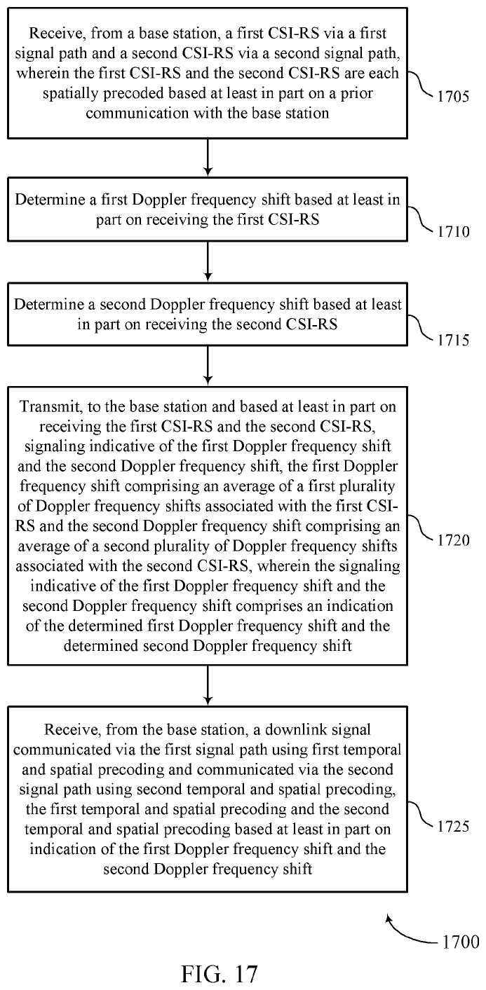

FIG. 17 shows a flowchart illustrating a method 1700 that supports temporal and spatial precoding of downlink signals in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1705, the method may include receiving, from a base station, a first CSI-RS via a first signal path and a second CSI-RS via a second signal path, where the first CSI-RS and the second CSI-RS are each spatially precoded based on a prior communication with the base station. The operations of 1705 may be performed in accordance with examples as disclosed herein. In some examples, aspects of the operations of 1705 may be performed by a CSI-RS reception component 1025 as described with reference to FIG. 10.

At 1710, the method may include determining a first Doppler frequency shift based on receiving the first CSI-RS. The operations of 1710 may be performed in accordance with examples as disclosed herein. In some examples, aspects of the operations of 1710 may be performed by a Doppler shift determination component 1040 as described with reference to FIG. 10.

At 1715, the method may include determining a second Doppler frequency shift based on receiving the second CSI-RS. The operations of 1715 may be performed in accordance with examples as disclosed herein. In some examples, aspects of the operations of 1715 may be performed by a Doppler shift determination component 1040 as described with reference to FIG. 10.

At 1720, the method may include transmitting, to the base station and based on receiving the first CSI-RS and the second CSI-RS, signaling indicative of the first Doppler frequency shift and the second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, where the signaling indicative of the first Doppler frequency shift and the second Doppler frequency shift comprises an indication of the determined first Doppler frequency shift and the determined second Doppler frequency shift. The operations of 1720 may be performed in accordance with examples as disclosed herein. In some examples, aspects of the operations of 1720 may be performed by a Doppler shift indication transmission component 1030 as described with reference to FIG. 10.

At 1725, the method may include receiving, from the base station, a downlink signal communicated via the first signal path using first temporal and spatial precoding and communicated via the second signal path using second temporal and spatial precoding, the first temporal and spatial precoding and the second temporal and spatial precoding based on the indication of the first Doppler frequency shift and the second Doppler frequency shift (e.g., the downlink signal may be a spatially and temporally precoded signal, such as one or more spatially and temporally precoded CSI-RSs). The operations of 1725 may be performed in accordance with examples as disclosed herein. In some examples, aspects of the operations of 1725 may be performed by a downlink signal reception component 1035 as described with reference to FIG. 10.

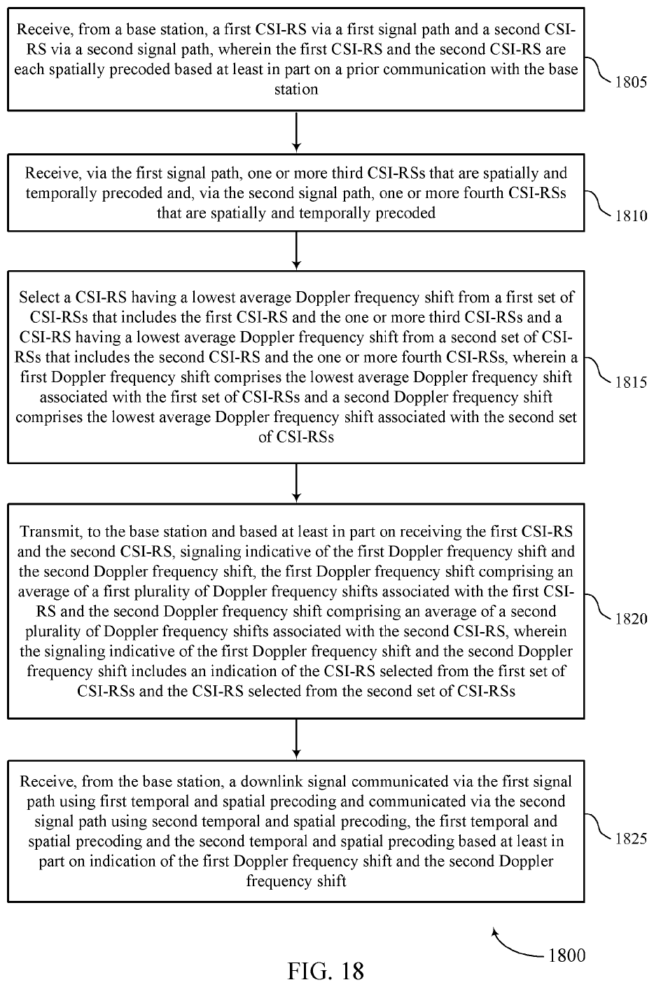

FIG. 18 shows a flowchart illustrating a method 1800 that supports temporal and spatial precoding of downlink signals in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1805, the method may include receiving, from a base station, a first CSI-RS via a first signal path and a second CSI-RS via a second signal path, where the first CSI-RS and the second CSI-RS are each spatially precoded based on a prior communication with the base station (e.g., and are each temporally precoded). The operations of 1805 may be performed in accordance with examples as disclosed herein. In some examples, aspects of the operations of 1805 may be performed by a CSI-RS reception component 1025 as described with reference to FIG. 10.

At 1810, the method may include receiving, via the first signal path, one or more third CSI-RSs that are spatially and temporally precoded and, via the second signal path, one or more fourth CSI-RSs that are spatially and temporally precoded. The operations of 1810 may be performed in accordance with examples as disclosed herein. In some examples, aspects of the operations of 1810 may be performed by a CSI-RS reception component 1025 as described with reference to FIG. 10.

At 1815, the method may include selecting a CSI-RS having a lowest average Doppler frequency shift from a first set of CSI-RSs that includes the first CSI-RS and the one or more third CSI-RSs and a CSI-RS having a lowest average Doppler frequency shift from a second set of CSI-RSs that includes the second CSI-RS and the one or more fourth CSI-RSs, where a first Doppler frequency shift includes the lowest average Doppler frequency shift associated with the first set of CSI-RSs and a second Doppler frequency shift includes the lowest average Doppler frequency shift associated with the second set of CSI-RSs. The operations of 1815 may be performed in accordance with examples as disclosed herein. In some examples, aspects of the operations of 1815 may be performed by a Doppler shift determination component 1040 as described with reference to FIG. 10.

At 1820, the method may include transmitting, to the base station and based on receiving the first CSI-RS and the second CSI-RS, signaling indicative of the first Doppler frequency shift and the second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, where the signaling indicative of the first Doppler frequency shift and the second Doppler frequency shift includes an indication of the CSI-RS selected from the first set of CSI-RSs and the CSI-RS selected from the second set of CSI-RSs. The operations of 1820 may be performed in accordance with examples as disclosed herein. In some examples, aspects of the operations of 1820 may be performed by a Doppler shift indication transmission component 1030 as described with reference to FIG. 10.

At 1825, the method may include receiving, from the base station, a downlink signal communicated via the first signal path using first temporal and spatial precoding and communicated via the second signal path using second temporal and spatial precoding, the first temporal and spatial precoding and the second temporal and spatial precoding based on the indication of the first Doppler frequency shift and the second Doppler frequency shift (e.g., the downlink signal may be a spatially and temporally precoded signal, such as one or more spatially and temporally precoded CSI-RSs). The operations of 1825 may be performed in accordance with examples as disclosed herein. In some examples, aspects of the operations of 1825 may be performed by a downlink signal reception component 1035 as described with reference to FIG. 10.

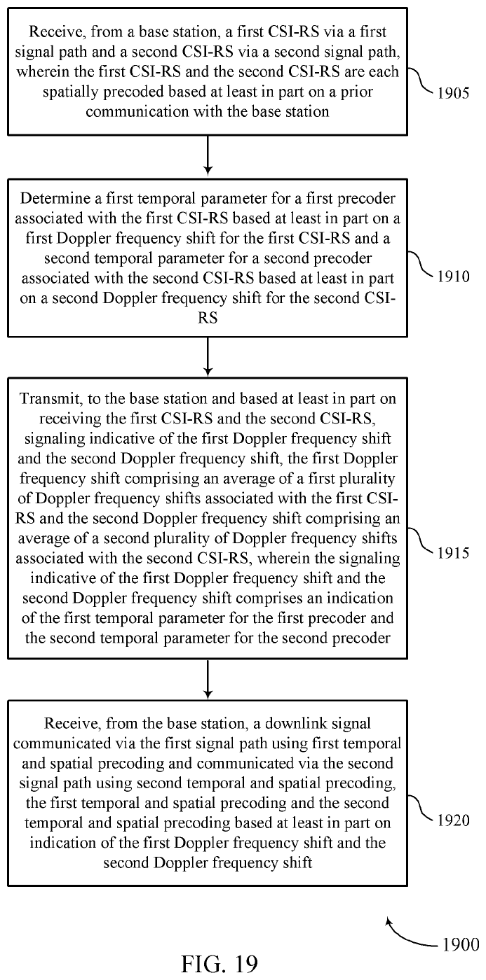

FIG. 19 shows a flowchart illustrating a method 1900 that supports temporal and spatial precoding of downlink signals in accordance with aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1905, the method may include receiving, from a base station, a first CSI-RS via a first signal path and a second CSI-RS via a second signal path, where the first CSI-RS and the second CSI-RS are each spatially precoded based on a prior communication with the base station. The operations of 1905 may be performed in accordance with examples as disclosed herein. In some examples, aspects of the operations of 1905 may be performed by a CSI-RS reception component 1025 as described with reference to FIG. 10.

At 1910, the method may include determining a first temporal parameter for a first precoder associated with the first CSI-RS based on the first Doppler frequency shift for the first CSI-RS and a second temporal parameter for a second precoder associated with the second CSI-RS based on the second Doppler frequency shift for the second CSI-RS. The operations of 1910 may be performed in accordance with examples as disclosed herein. In some examples, aspects of the operations of 1910 may be performed by a Doppler shift determination component 1040 as described with reference to FIG. 10.

At 1915, the method may include transmitting, to the base station and based on receiving the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, where the signaling indicative of the first Doppler frequency shift and the second Doppler frequency shift includes an indication of the first temporal parameter for the first precoder and the second temporal parameter for the second precoder. The operations of 1915 may be performed in accordance with examples as disclosed herein. In some examples, aspects of the operations of 1915 may be performed by a Doppler shift indication transmission component 1030 as described with reference to FIG. 10.

At 1920, the method may include receiving, from the base station, a downlink signal communicated via the first signal path using first temporal and spatial precoding and communicated via the second signal path using second temporal and spatial precoding, the first temporal and spatial precoding and the second temporal and spatial precoding based on the indication of the first Doppler frequency shift and the second Doppler frequency shift. The operations of 1920 may be performed in accordance with examples as disclosed herein. In some examples, aspects of the operations of 1920 may be performed by a downlink signal reception component 1035 as described with reference to FIG. 10.

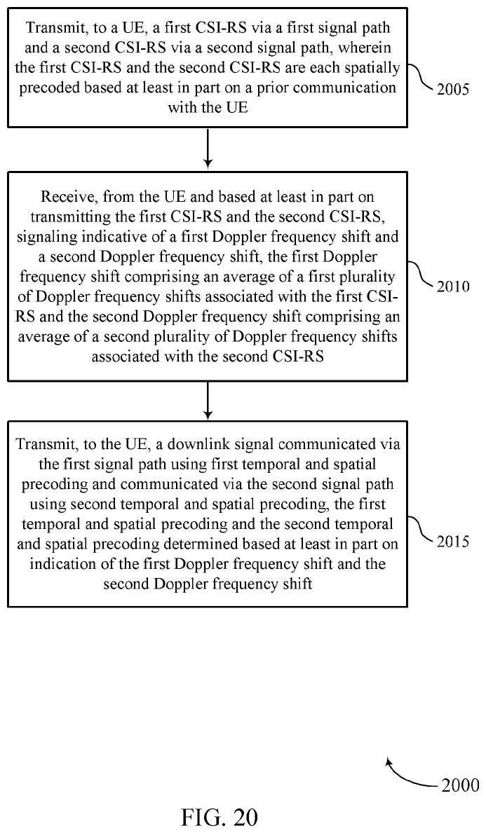

FIG. 20 shows a flowchart illustrating a method 2000 that supports temporal and spatial precoding of downlink signals in accordance with aspects of the present disclosure. The operations of the method 2000 may be implemented by a base station or its components as described herein. For example, the operations of the method 2000 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 2005, the method may include transmitting, to a UE, a first CSI-RS via a first signal path and a second CSI-RS via a second signal path, where the first CSI-RS and the second CSI-RS are each spatially precoded based on a prior communication with the UE. The operations of 2005 may be performed in accordance with examples as disclosed herein. In some examples, aspects of the operations of 2005 may be performed by a CSI-RS transmission component 1425 as described with reference to FIG. 14.

At 2010, the method may include receiving, from the UE and based on transmitting the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS. The operations of 2010 may be performed in accordance with examples as disclosed herein. In some examples, aspects of the operations of 2010 may be performed by a Doppler shift indication reception component 1430 as described with reference to FIG. 14.

At 2015, the method may include transmitting, to the UE, a downlink signal communicated via the first signal path using first temporal and spatial precoding and communicated via the second signal path using second temporal and spatial precoding, the first temporal and spatial precoding and the second temporal and spatial precoding determined based on the indication of the first Doppler frequency shift and the second Doppler frequency shift. The operations of 2015 may be performed in accordance with examples as disclosed herein. In some examples, aspects of the operations of 2015 may be performed by a downlink signal transmission component 1435 as described with reference to FIG. 14.

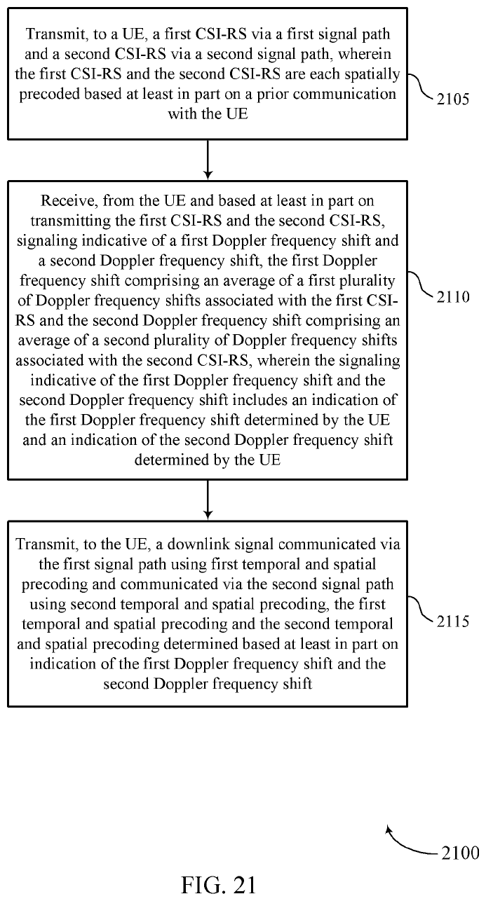

FIG. 21 shows a flowchart illustrating a method 2100 that supports temporal and spatial precoding of downlink signals in accordance with aspects of the present disclosure. The operations of the method 2100 may be implemented by a base station or its components as described herein. For example, the operations of the method 2100 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 2105, the method may include transmitting, to a UE, a first CSI-RS via a first signal path and a second CSI-RS via a second signal path, where the first CSI-RS and the second CSI-RS are each spatially precoded based on a prior communication with the UE. The operations of 2105 may be performed in accordance with examples as disclosed herein. In some examples, aspects of the operations of 2105 may be performed by a CSI-RS transmission component 1425 as described with reference to FIG. 14.

At 2110, the method may include receiving, from the UE and based on transmitting the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, where the signaling indicative of the first Doppler frequency shift and the second Doppler frequency shift includes an indication of the first Doppler frequency shift determined by the UE and an indication of the second Doppler frequency shift determined by the UE. The operations of 2110 may be performed in accordance with examples as disclosed herein. In some examples, aspects of the operations of 2110 may be performed by a Doppler shift indication reception component 1430 as described with reference to FIG. 14.

At 2115, the method may include transmitting, to the UE, a downlink signal communicated via the first signal path using first temporal and spatial precoding and communicated via the second signal path using second temporal and spatial precoding, the first temporal and spatial precoding and the second temporal and spatial precoding determined based on the indication of the first Doppler frequency shift and the second Doppler frequency shift. The operations of 2115 may be performed in accordance with examples as disclosed herein. In some examples, aspects of the operations of 2115 may be performed by a downlink signal transmission component 1435 as described with reference to FIG. 14.

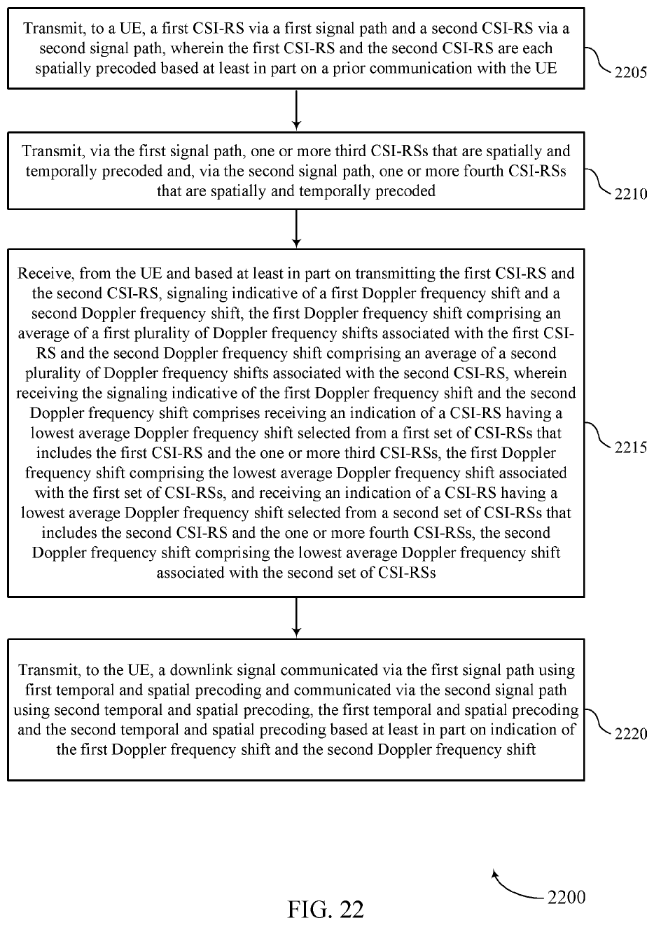

FIG. 22 shows a flowchart illustrating a method 2200 that supports temporal and spatial precoding of downlink signals in accordance with aspects of the present disclosure. The operations of the method 2200 may be implemented by a base station or its components as described herein. For example, the operations of the method 2200 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 2205, the method may include transmitting, to a UE, a first CSI-RS via a first signal path and a second CSI-RS via a second signal path, where the first CSI-RS and the second CSI-RS are each spatially precoded based on a prior communication with the UE. The operations of 2205 may be performed in accordance with examples as disclosed herein. In some examples, aspects of the operations of 2205 may be performed by a CSI-RS transmission component 1425 as described with reference to FIG. 14.

At 2210, the method may include transmitting, via the first signal path, one or more third CSI-RSs that are spatially and temporally precoded and, via the second signal path, one or more fourth CSI-RSs that are spatially and temporally precoded. The operations of 2210 may be performed in accordance with examples as disclosed herein. In some examples, aspects of the operations of 2210 may be performed by a CSI-RS transmission component 1425 as described with reference to FIG. 14.

At 2215, the method may include receiving, from the UE and based on transmitting the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, where receiving the signaling indicative of the first Doppler frequency shift and the second Doppler frequency shift includes receiving an indication of a CSI-RS having a lowest average Doppler frequency shift selected from a first set of CSI-RSs that includes the first CSI-RS and the one or more third CSI-RSs, the first Doppler frequency shift including the lowest average Doppler frequency shift associated with the first set of CSI-RSs, and receiving an indication of a CSI-RS having a lowest average Doppler frequency shift selected from a second set of CSI-RSs that includes the second CSI-RS and the one or more fourth CSI-RSs, the second Doppler frequency shift including the lowest average Doppler frequency shift associated with the second set of CSI-RSs. The operations of 2215 may be performed in accordance with examples as disclosed herein. In some examples, aspects of the operations of 2215 may be performed by a Doppler shift indication reception component 1430 as described with reference to FIG. 14.

At 2220, the method may include transmitting, to the UE, a downlink signal communicated via the first signal path using first temporal and spatial precoding and communicated via the second signal path using second temporal and spatial precoding, the first temporal and spatial precoding and the second temporal and spatial precoding determined based on the indication of the first Doppler frequency shift and the second Doppler frequency shift. The operations of 2220 may be performed in accordance with examples as disclosed herein. In some examples, aspects of the operations of 2220 may be performed by a downlink signal transmission component 1435 as described with reference to FIG. 14.

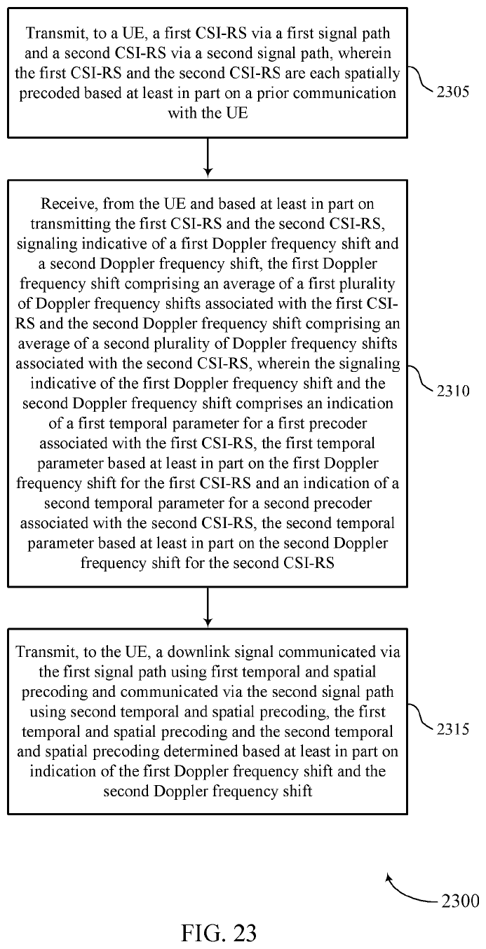

FIG. 23 shows a flowchart illustrating a method 2300 that supports temporal and spatial precoding of downlink signals in accordance with aspects of the present disclosure. The operations of the method 2300 may be implemented by a base station or its components as described herein. For example, the operations of the method 2300 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 2305, the method may include transmitting, to a UE, a first CSI-RS via a first signal path and a second CSI-RS via a second signal path, where the first CSI-RS and the second CSI-RS are each spatially precoded based on a prior communication with the UE. The operations of 2305 may be performed in accordance with examples as disclosed herein. In some examples, aspects of the operations of 2305 may be performed by a CSI-RS transmission component 1425 as described with reference to FIG. 14.

At 2310, the method may include receiving, from the UE and based on transmitting the first CSI-RS and the second CSI-RS, signaling indicative of a first Doppler frequency shift and a second Doppler frequency shift, the first Doppler frequency shift including an average of a first set of multiple Doppler frequency shifts associated with the first CSI-RS and the second Doppler frequency shift including an average of a second set of multiple Doppler frequency shifts associated with the second CSI-RS, where the signaling indicative of the first Doppler frequency shift and the second Doppler frequency shift includes an indication of a first temporal parameter for a first precoder associated with the first CSI-RS, the first temporal parameter based on the first Doppler frequency shift for the first CSI-RS and an indication of a second temporal parameter for a second precoder associated with the second CSI-RS, the second temporal parameter based on the second Doppler frequency shift for the second CSI-RS. The operations of 2310 may be performed in accordance with examples as disclosed herein. In some examples, aspects of the operations of 2310 may be performed by a Doppler shift indication reception component 1430 as described with reference to FIG. 14.

At 2315, the method may include transmitting, to the UE, a downlink signal communicated via the first signal path using first temporal and spatial precoding and communicated via the second signal path using second temporal and spatial precoding, the first temporal and spatial precoding and the second temporal and spatial precoding determined based on the indication of the first Doppler frequency shift and the second Doppler frequency shift. The operations of 2315 may be performed in accordance with examples as disclosed herein. In some examples, aspects of the operations of 2315 may be performed by a downlink signal transmission component 1435 as described with reference to FIG. 14.

The following provides an overview of aspects of the present disclosure:

Aspect 1: A method for wireless communication at a UE, comprising: receiving, from a base station, a first CSI-RS via a first signal path and a second CSI-RS via a second signal path, wherein the first CSI-RS and the second CSI-RS are each spatially precoded based at least in part on a prior communication with the base station; transmitting, to the base station and based at least in part on receiving the first CSI-RS and the second CSI-RS, signaling indicative of a first Doppler frequency shift and a second Doppler frequency shift, the first Doppler frequency shift comprising an average of a first plurality of Doppler frequency shifts associated with the first CSI-RS and the second Doppler frequency shift comprising an average of a second plurality of Doppler frequency shifts associated with the second CSI-RS; and receiving, from the base station, a downlink signal communicated via the first signal path using first temporal and spatial precoding and communicated via the second signal path using second temporal and spatial precoding, the first temporal and spatial precoding and the second temporal and spatial precoding based at least in part on the indication of the first Doppler frequency shift and the second Doppler frequency shift.

Aspect 2: The method of aspect 1, further comprising: determining the first Doppler frequency shift based at least in part on receiving the first CSI-RS, wherein the signaling indicative of the first Doppler frequency shift comprises an indication of the determined first Doppler frequency shift; and determining the second Doppler frequency shift based at least in part on receiving the second CSI-RS, wherein the signaling indicative of the second Doppler frequency shift comprises an indication of the determined second Doppler frequency shift.

Aspect 3: The method of aspect 2, wherein the first Doppler frequency shift comprises the average of the first plurality of Doppler frequency shifts divided by a Doppler frequency shift, and the second Doppler frequency shift comprises the average of the second plurality of Doppler frequency shifts divided by the Doppler frequency shift.

Aspect 4: The method of any of aspects 2 through 3, wherein the first CSI-RS corresponds to a first CSI-RS port; the second CSI-RS corresponds to a second CSI-RS port; and the first CSI-RS port and the second CSI-RS port correspond to a same CSI-RS port group or CSI-RS resource.

Aspect 5: The method of any of aspects 2 through 3, wherein the first CSI-RS corresponds to a first CSI-RS resource; the second CSI-RS corresponds to a second CSI-RS resource; and the first CSI-RS resource and the second CSI-RS resource correspond to a same CSI-RS resource set.

Aspect 6: The method of any of aspects 1 through 5, wherein the first CSI-RS and the second CSI-RS are each temporally precoded, the method further comprising: receiving, via the first signal path, one or more third CSI-RSs that are spatially and temporally precoded; receiving, via the second signal path, one or more fourth CSI-RSs that are spatially and temporally precoded; selecting a CSI-RS having a lowest average Doppler frequency shift from a first set of CSI-RSs that includes the first CSI-RS and the one or more third CSI-RSs, wherein the signaling indicative of the first Doppler frequency shift includes an indication of the CSI-RS selected from the first set of CSI-RSs, and wherein the first Doppler frequency shift comprises the lowest average Doppler frequency shift associated with the first set of CSI-RSs; and selecting a CSI-RS having a lowest average Doppler frequency shift from a second set of CSI-RSs that includes the second CSI-RS and the one or more fourth CSI-RSs, wherein the signaling indicative of the second Doppler frequency shift includes an indication of the CSI-RS selected from the second set of CSI-RSs, and wherein the second Doppler frequency shift comprises the lowest average Doppler frequency shift associated with the second set of CSI-RSs.

Aspect 7: The method of aspect 6, wherein each CSI-RS of the first set of CSI-RSs is spatially precoded using a first spatial precoding; each CSI-RS of the second set of CSI-RSs is spatially precoded using a second spatial precoding; each CSI-RS of the first set of CSI-RSs is temporally precoded using different temporal precoding; and each CSI-RS of the second set of CSI-RSs is temporally precoded using different temporal precoding.

Aspect 8: The method of any of aspects 6 through 7, wherein the first CSI-RS corresponds to a first CSI-RS port; the one or more third CSI-RSs each correspond to a respective third CSI-RS port; the first CSI-RS port and the one or more third CSI-RS ports correspond to a first CSI-RS port group or a first CSI-RS resource; the second CSI-RS corresponds to a second CSI-RS port; the one or more fourth CSI-RSs each correspond to a respective fourth CSI-RS port; and the second CSI-RS port and the one or more fourth CSI-RS ports correspond to a second CSI-RS port group or a second CSI-RS resource.

Aspect 9: The method of any of aspects 6 through 7, wherein the first CSI-RS corresponds to a first CSI-RS resource; the one or more third CSI-RSs each correspond to a respective third CSI-RS resource; the first CSI-RS resource and the one or more third CSI-RS resources correspond to a first CSI-RS resource set; the second CSI-RS corresponds to a second CSI-RS resource; the one or more fourth CSI-RSs each correspond to a respective fourth CSI-RS resource; and the second CSI-RS resource and the one or more fourth CSI-RS resources correspond to a second CSI-RS resource set.

Aspect 10: The method of any of aspects 1 through 9, further comprising: determining a first temporal parameter for a first precoder associated with the first CSI-RS based at least in part on the first Doppler frequency shift for the first CSI-RS, wherein the signaling indicative of the first Doppler frequency shift comprises an indication of the first temporal parameter for the first precoder; and determining a second temporal parameter for a second precoder associated with the second CSI-RS based at least in part on the second Doppler frequency shift for the second CSI-RS, wherein the signaling indicative of the second Doppler frequency shift comprises an indication of the second temporal parameter for the second precoder.

Aspect 11: The method of aspect 10, wherein the first temporal and spatial precoding for the downlink signal uses the first precoder and the first temporal parameter, and the second temporal and spatial precoding for the downlink signal uses the second precoder and the second temporal parameter.

Aspect 12: The method of any of aspects 1 through 11, wherein the downlink signal comprises a CSI-RS, a demodulation reference signal, a downlink control channel, a downlink shared channel, or any combination thereof.

Aspect 13: A method for wireless communication at a base station, comprising: transmitting, to a UE, a first CSI-RS via a first signal path and a second CSI-RS via a second signal path, wherein the first CSI-RS and the second CSI-RS are each spatially precoded based at least in part on a prior communication with the UE; receiving, from the UE and based at least in part on transmitting the first CSI-RS and the second CSI-RS, signaling indicative of a first Doppler frequency shift and a second Doppler frequency shift, the first Doppler frequency shift comprising an average of a first plurality of Doppler frequency shifts associated with the first CSI-RS and the second Doppler frequency shift comprising an average of a second plurality of Doppler frequency shifts associated with the second CSI-RS; and transmitting, to the UE, a downlink signal communicated via the first signal path using first temporal and spatial precoding and communicated via the second signal path using second temporal and spatial precoding, the first temporal and spatial precoding and the second temporal and spatial precoding determined based at least in part on the indication of the first Doppler frequency shift and the second Doppler frequency shift.

Aspect 14: The method of aspect 13, wherein receiving the signaling indicative of the first Doppler frequency shift and the second Doppler frequency shift comprises: receiving an indication of the first Doppler frequency shift determined by the UE and an indication of the second Doppler frequency shift determined by the UE.

Aspect 15: The method of aspect 14, wherein the first Doppler frequency shift comprises the average of the first plurality of Doppler frequency shifts divided by a Doppler frequency shift, and the second Doppler frequency shift comprises the average of the second plurality of Doppler frequency shifts divided by the Doppler frequency shift.

Aspect 16: The method of any of aspects 14 through 15, wherein the first CSI-RS corresponds to a first CSI-RS port; the second CSI-RS corresponds to a second CSI-RS port; and the first CSI-RS port and the second CSI-RS port correspond to a same CSI-RS port group or CSI-RS resource.

Aspect 17: The method of any of aspects 14 through 15, wherein the first CSI-RS corresponds to a first CSI-RS resource; the second CSI-RS corresponds to a second CSI-RS resource; and the first CSI-RS resource and the second CSI-RS resource correspond to a same CSI-RS resource set.

Aspect 18: The method of any of aspects 13 through 17, wherein the first CSI-RS and the second CSI-RS are each temporally precoded, the method further comprising: transmitting, via the first signal path, one or more third CSI-RSs that are spatially and temporally precoded; and transmitting, via the second signal path, one or more fourth CSI-RSs that are spatially and temporally precoded.

Aspect 19: The method of aspect 18, wherein receiving the signaling indicative of the first Doppler frequency shift and the second Doppler frequency shift comprises: receiving an indication of a CSI-RS having a lowest average Doppler frequency shift selected from a first set of CSI-RSs that includes the first CSI-RS and the one or more third CSI-RSs, the first Doppler frequency shift comprising the lowest average Doppler frequency shift associated with the first set of CSI-RSs; and receiving an indication of a CSI-RS having a lowest average Doppler frequency shift selected from a second set of CSI-RSs that includes the second CSI-RS and the one or more fourth CSI-RSs, the second Doppler frequency shift comprising the lowest average Doppler frequency shift associated with the second set of CSI-RSs.

Aspect 20: The method of aspect 19, wherein each CSI-RS of the first set of CSI-RSs is spatially precoded using a first spatial precoding; each CSI-RS of the second set of CSI-RSs is spatially precoded using a second spatial precoding; each CSI-RS of the first set of CSI-RSs is temporally precoded using different temporal precoding; and each CSI-RS of the second set of CSI-RSs is temporally precoded using different temporal precoding.

Aspect 21: The method of any of aspects 18 through 20, wherein the first CSI-RS corresponds to a first CSI-RS port; the one or more third CSI-RSs each correspond to a respective third CSI-RS port; the first CSI-RS port and the one or more third CSI-RS ports correspond to a first CSI-RS port group or a first CSI-RS resource; the second CSI-RS corresponds to a second CSI-RS port; the one or more fourth CSI-RSs each correspond to a respective fourth CSI-RS port; and the second CSI-RS port and the one or more fourth CSI-RS ports correspond to a second CSI-RS port group or a second CSI-RS resource.

Aspect 22: The method of any of aspects 18 through 20, wherein the first CSI-RS corresponds to a first CSI-RS resource; the one or more third CSI-RSs each correspond to a respective third CSI-RS resource; the first CSI-RS resource and the one or more third CSI-RS resources correspond to a first CSI-RS resource set; the second CSI-RS corresponds to a second CSI-RS resource; the one or more fourth CSI-RSs each correspond to a respective fourth CSI-RS resource; and the second CSI-RS resource and the one or more fourth CSI-RS resources correspond to a second CSI-RS resource set.

Aspect 23: The method of any of aspects 13 through 22, wherein receiving the signaling indicative of the first Doppler frequency shift and the second Doppler frequency shift comprises: receiving an indication of a first temporal parameter for a first precoder associated with the first CSI-RS, the first temporal parameter based at least in part on the first Doppler frequency shift for the first CSI-RS; and receiving an indication of a second temporal parameter for a second precoder associated with the second CSI-RS, the second temporal parameter based at least in part on the second Doppler frequency shift for the second CSI-RS.

Aspect 24: The method of aspect 23, wherein the first temporal and spatial precoding for the downlink signal uses the first precoder and the first temporal parameter, and the second temporal and spatial precoding for the downlink signal uses the second precoder and the second temporal parameter.

Aspect 25: The method of any of aspects 13 through 24, wherein the downlink signal comprises a CSI-RS, a demodulation reference signal, a downlink control channel, a downlink shared channel, or any combination thereof.

Aspect 26: An apparatus for wireless communication at a UE, comprising a processor; memory coupled with the processor; and instructions stored in the memory and executable by the processor to cause the apparatus to perform a method of any of aspects 1 through 12.

Aspect 27: An apparatus for wireless communication at a UE, comprising at least one means for performing a method of any of aspects 1 through 12.

Aspect 28: A non-transitory computer-readable medium storing code for wireless communication at a UE, the code comprising instructions executable by a processor to perform a method of any of aspects 1 through 12.

Aspect 29: An apparatus for wireless communication at a base station, comprising a processor; memory coupled with the processor; and instructions stored in the memory and executable by the processor to cause the apparatus to perform a method of any of aspects 13 through 25.

Aspect 30: An apparatus for wireless communication at a base station, comprising at least one means for performing a method of any of aspects 13 through 25.

Aspect 31: A non-transitory computer-readable medium storing code for wireless communication at a base station, the code comprising instructions executable by a processor to perform a method of any of aspects 13 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, a first channel state information reference signal via a first signal path and a second channel state information reference signal via a second signal path, wherein the first channel state information reference signal and the second channel state information reference signal are each spatially precoded based at least in part on a prior communication with the base station;
transmitting, to the base station and based at least in part on receiving the first channel state information reference signal and the second channel state information reference signal, signaling indicative of a first Doppler frequency shift and a second Doppler frequency shift, the first Doppler frequency shift based at least in part on an average of a first plurality of Doppler frequency shifts associated with the first channel state information reference signal and the second Doppler frequency shift based at least in part on an average of a second plurality of Doppler frequency shifts associated with the second channel state information reference signal; and
receiving, from the base station, a downlink signal communicated via at least one of the first signal path using first temporal and spatial precoding or the second signal path using second temporal and spatial precoding, the first temporal and spatial precoding and the second temporal and spatial precoding based at least in part on the signaling indicative of the first Doppler frequency shift and the second Doppler frequency shift.

2. The method of claim 1, further comprising:
determining the first Doppler frequency shift based at least in part on receiving the first channel state information reference signal, wherein the signaling indicative of the first Doppler frequency shift comprises an indication of the determined first Doppler frequency shift; and
determining the second Doppler frequency shift based at least in part on receiving the second channel state information reference signal, wherein the signaling indicative of the second Doppler frequency shift comprises an indication of the determined second Doppler frequency shift.

3. The method of claim 2, wherein the first Doppler frequency shift comprises the average of the first plurality of Doppler frequency shifts divided by a Doppler frequency shift, and wherein the second Doppler frequency shift comprises the average of the second plurality of Doppler frequency shifts divided by the Doppler frequency shift.

4. The method of claim 2, wherein:
the first channel state information reference signal corresponds to a first channel state information reference signal port;
the second channel state information reference signal corresponds to a second channel state information reference signal port; and
the first channel state information reference signal port and the second channel state information reference signal port correspond to a same channel state information reference signal port group or channel state information reference signal resource.

5. The method of claim 2, wherein:
the first channel state information reference signal corresponds to a first channel state information reference signal resource;
the second channel state information reference signal corresponds to a second channel state information reference signal resource; and
the first channel state information reference signal resource and the second channel state information reference signal resource correspond to a same channel state information reference signal resource set.

6. The method of claim 1, wherein the first channel state information reference signal and the second channel state information reference signal are each temporally precoded, the method further comprising:
receiving, via the first signal path, one or more third channel state information reference signals that are spatially and temporally precoded;
receiving, via the second signal path, one or more fourth channel state information reference signals that are spatially and temporally precoded;
selecting a channel state information reference signal having a lowest average Doppler frequency shift from a first set of channel state information reference signals that includes the first channel state information reference signal and the one or more third channel state information reference signals, wherein the signaling indicative of the first Doppler frequency shift includes an indication of the channel state information reference signal selected from the first set of channel state information reference signals, and wherein the first Doppler frequency shift comprises the lowest average Doppler frequency shift associated with the first set of channel state information reference signals; and
selecting a channel state information reference signal having a lowest average Doppler frequency shift from a second set of channel state information reference signals that includes the second channel state information reference signal and the one or more fourth channel state information reference signals, wherein the signaling indicative of the second Doppler frequency shift includes an indication of the channel state information reference signal selected from the second set of channel state information reference signals, and wherein the second Doppler frequency shift comprises the lowest average Doppler frequency shift associated with the second set of channel state information reference signals.

7. The method of claim 6, wherein:
each channel state information reference signal of the first set of channel state information reference signals is spatially precoded using a first spatial precoding;
each channel state information reference signal of the second set of channel state information reference signals is spatially precoded using a second spatial precoding;
each channel state information reference signal of the first set of channel state information reference signals is temporally precoded using a different temporal precoding; and
each channel state information reference signal of the second set of channel state information reference signals is temporally precoded using a different temporal precoding.

8. The method of claim 6, wherein:
the first channel state information reference signal corresponds to a first channel state information reference signal port;
the one or more third channel state information reference signals each correspond to a respective third channel state information reference signal port;
the first channel state information reference signal port and the one or more third channel state information reference signal ports correspond to a first channel state information reference signal port group or a first channel state information reference signal resource;
the second channel state information reference signal corresponds to a second channel state information reference signal port;
the one or more fourth channel state information reference signals each correspond to a respective fourth channel state information reference signal port; and
the second channel state information reference signal port and the one or more fourth channel state information reference signal ports correspond to a second channel state information reference signal port group or a second channel state information reference signal resource.

9. The method of claim 6, wherein:
the first channel state information reference signal corresponds to a first channel state information reference signal resource;
the one or more third channel state information reference signals each correspond to a respective third channel state information reference signal resource;
the first channel state information reference signal resource and the one or more third channel state information reference signal resources correspond to a first channel state information reference signal resource set;
the second channel state information reference signal corresponds to a second channel state information reference signal resource;
the one or more fourth channel state information reference signals each correspond to a respective fourth channel state information reference signal resource; and
the second channel state information reference signal resource and the one or more fourth channel state information reference signal resources correspond to a second channel state information reference signal resource set.

10. The method of claim 1, further comprising:
determining a first temporal parameter for a first precoder associated with the first channel state information reference signal based at least in part on the first Doppler frequency shift for the first channel state information reference signal, wherein the signaling indicative of the first Doppler frequency shift comprises an indication of the first temporal parameter for the first precoder; and
determining a second temporal parameter for a second precoder associated with the second channel state information reference signal based at least in part on the second Doppler frequency shift for the second channel state information reference signal, wherein the signaling indicative of the second Doppler frequency shift comprises an indication of the second temporal parameter for the second precoder.

11. The method of claim 10, wherein the first temporal and spatial precoding for the downlink signal uses the first precoder and the first temporal parameter, and wherein the second temporal and spatial precoding for the downlink signal uses the second precoder and the second temporal parameter.

12. The method of claim 1, wherein the downlink signal comprises a channel state information reference signal, a demodulation reference signal, a downlink control channel, a downlink shared channel, or any combination thereof.

13. A method for wireless communication at a base station, comprising:
transmitting, to a user equipment (UE), a first channel state information reference signal via a first signal path and a second channel state information reference signal via a second signal path, wherein the first channel state information reference signal and the second channel state information reference signal are each spatially precoded based at least in part on a prior communication with the UE;
receiving, from the UE and based at least in part on transmitting the first channel state information reference signal and the second channel state information reference signal, signaling indicative of a first Doppler frequency shift and a second Doppler frequency shift, the first Doppler frequency shift based at least in part on an average of a first plurality of Doppler frequency shifts associated with the first channel state information reference signal and the second Doppler frequency shift based at least in part on an average of a second plurality of Doppler frequency shifts associated with the second channel state information reference signal; and
transmitting, to the UE, a downlink signal communicated via the first signal path using first temporal and spatial precoding and communicated via the second signal path using second temporal and spatial precoding, the first temporal and spatial precoding and the second temporal and spatial precoding determined based at least in part on the signaling indicative of the first Doppler frequency shift and the second Doppler frequency shift.

14. The method of claim 13, wherein receiving the signaling indicative of the first Doppler frequency shift and the second Doppler frequency shift comprises:
receiving an indication of the first Doppler frequency shift determined by the UE and an indication of the second Doppler frequency shift determined by the UE.

15. The method of claim 14, wherein the first Doppler frequency shift comprises the average of the first plurality of Doppler frequency shifts divided by a Doppler frequency shift, and wherein the second Doppler frequency shift comprises the average of the second plurality of Doppler frequency shifts divided by the Doppler frequency shift.

16. The method of claim 14, wherein:
the first channel state information reference signal corresponds to a first channel state information reference signal port;
the second channel state information reference signal corresponds to a second channel state information reference signal port; and
the first channel state information reference signal port and the second channel state information reference signal port correspond to a same channel state information reference signal port group or channel state information reference signal resource.

17. The method of claim 14, wherein:
the first channel state information reference signal corresponds to a first channel state information reference signal resource;
the second channel state information reference signal corresponds to a second channel state information reference signal resource; and
the first channel state information reference signal resource and the second channel state information reference signal resource correspond to a same channel state information reference signal resource set.

18. The method of claim 13, wherein the first channel state information reference signal and the second channel state information reference signal are each temporally precoded, the method further comprising:
transmitting, via the first signal path, one or more third channel state information reference signals that are spatially and temporally precoded; and
transmitting, via the second signal path, one or more fourth channel state information reference signals that are spatially and temporally precoded.

19. The method of claim 18, wherein receiving the signaling indicative of the first Doppler frequency shift and the second Doppler frequency shift comprises:
receiving an indication of a channel state information reference signal having a lowest average Doppler frequency shift selected from a first set of channel state information reference signals that includes the first channel state information reference signal and the one or more third channel state information reference signals, the first Doppler frequency shift comprising the lowest average Doppler frequency shift associated with the first set of channel state information reference signals; and
receiving an indication of a channel state information reference signal having a lowest average Doppler frequency shift selected from a second set of channel state information reference signals that includes the second channel state information reference signal and the one or more fourth channel state information reference signals, the second Doppler frequency shift comprising the lowest average Doppler frequency shift associated with the second set of channel state information reference signals.

20. The method of claim 19, wherein:
each channel state information reference signal of the first set of channel state information reference signals is spatially precoded using a first spatial precoding;
each channel state information reference signal of the second set of channel state information reference signals is spatially precoded using a second spatial precoding;
each channel state information reference signal of the first set of channel state information reference signals is temporally precoded using a different temporal precoding; and
each channel state information reference signal of the second set of channel state information reference signals is temporally precoded using a different temporal precoding.

21. The method of claim 18, wherein:
the first channel state information reference signal corresponds to a first channel state information reference signal port;
the one or more third channel state information reference signals each correspond to a respective third channel state information reference signal port;
the first channel state information reference signal port and the one or more third channel state information reference signal ports correspond to a first channel state information reference signal port group or a first channel state information reference signal resource;
the second channel state information reference signal corresponds to a second channel state information reference signal port;
the one or more fourth channel state information reference signals each correspond to a respective fourth channel state information reference signal port; and
the second channel state information reference signal port and the one or more fourth channel state information reference signal ports correspond to a second channel state information reference signal port group or a second channel state information reference signal resource.

22. The method of claim 18, wherein:
the first channel state information reference signal corresponds to a first channel state information reference signal resource;
the one or more third channel state information reference signals each correspond to a respective third channel state information reference signal resource;
the first channel state information reference signal resource and the one or more third channel state information reference signal resources correspond to a first channel state information reference signal resource set;
the second channel state information reference signal corresponds to a second channel state information reference signal resource;
the one or more fourth channel state information reference signals each correspond to a respective fourth channel state information reference signal resource; and
the second channel state information reference signal resource and the one or more fourth channel state information reference signal resources correspond to a second channel state information reference signal resource set.

23. The method of claim 13, wherein receiving the signaling indicative of the first Doppler frequency shift and the second Doppler frequency shift comprises:
receiving an indication of a first temporal parameter for a first precoder associated with the first channel state information reference signal, the first temporal parameter based at least in part on the first Doppler frequency shift for the first channel state information reference signal; and
receiving an indication of a second temporal parameter for a second precoder associated with the second channel state information reference signal, the second temporal parameter based at least in part on the second Doppler frequency shift for the second channel state information reference signal.

24. The method of claim 23, wherein the first temporal and spatial precoding for the downlink signal uses the first precoder and the first temporal parameter, and wherein the second temporal and spatial precoding for the downlink signal uses the second precoder and the second temporal parameter.

25. The method of claim 13, wherein the downlink signal comprises a channel state information reference signal, a demodulation reference signal, a downlink control channel, a downlink shared channel, or any combination thereof

26. An apparatus for wireless communication at a user equipment (UE), comprising:
a processor;
memory coupled with the processor; and
instructions stored in the memory and executable by the processor to cause the apparatus to:
receive, from a base station, a first channel state information reference signal via a first signal path and a second channel state information reference signal via a second signal path, wherein the first channel state information reference signal and the second channel state information reference signal are each spatially precoded based at least in part on a prior communication with the base station;
transmit, to the base station and based at least in part on receiving the first channel state information reference signal and the second channel state information reference signal, signaling indicative of a first Doppler frequency shift and a second Doppler frequency shift, the first Doppler frequency shift based at least in part on an average of a first plurality of Doppler frequency shifts associated with the first channel state information reference signal and the second Doppler frequency shift based at least in part on an average of a second plurality of Doppler frequency shifts associated with the second channel state information reference signal; and
receive, from the base station, a downlink signal communicated via the first signal path using first temporal and spatial precoding and communicated via the second signal path using second temporal and spatial precoding, the first temporal and spatial precoding and the second temporal and spatial precoding based at least in part on the signaling indicative of the first Doppler frequency shift and the second Doppler frequency shift.

27. The apparatus of claim 26, wherein the instructions are further executable by the processor to cause the apparatus to:
determine the first Doppler frequency shift based at least in part on receiving the first channel state information reference signal, wherein the signaling indicative of the first Doppler frequency shift comprises an indication of the determined first Doppler frequency shift; and
determine the second Doppler frequency shift based at least in part on receiving the second channel state information reference signal, wherein the signaling indicative of the second Doppler frequency shift comprises an indication of the determined second Doppler frequency shift.

28. The apparatus of claim 26, wherein the first channel state information reference signal and the second channel state information reference signal are each temporally precoded, and the instructions are further executable by the processor to cause the apparatus to:
receive, via the first signal path, one or more third channel state information reference signals that are spatially and temporally precoded;
receive, via the second signal path, one or more fourth channel state information reference signals that are spatially and temporally precoded;
select a channel state information reference signal having a lowest average Doppler frequency shift from a first set of channel state information reference signals that includes the first channel state information reference signal and the one or more third channel state information reference signals, wherein the signaling indicative of the first Doppler frequency shift includes an indication of the channel state information reference signal selected from the first set of channel state information reference signals, and wherein the first Doppler frequency shift comprises the lowest average Doppler frequency shift associated with the first set of channel state information reference signals; and
select a channel state information reference signal having a lowest average Doppler frequency shift from a second set of channel state information reference signals that includes the second channel state information reference signal and the one or more fourth channel state information reference signals, wherein the signaling indicative of the second Doppler frequency shift includes an indication of the channel state information reference signal selected from the second set of channel state information reference signals, and wherein the second Doppler frequency shift comprises the lowest average Doppler frequency shift associated with the second set of channel state information reference signals.

29. The apparatus of claim 26, wherein the instructions are further executable by the processor to cause the apparatus to:
determine a first temporal parameter for a first precoder associated with the first channel state information reference signal based at least in part on the first Doppler frequency shift for the first channel state information reference signal, wherein the signaling indicative of the first Doppler frequency shift comprises an indication of the first temporal parameter for the first precoder; and
determine a second temporal parameter for a second precoder associated with the second channel state information reference signal based at least in part on the second Doppler frequency shift for the second channel state information reference signal, wherein the signaling indicative of the second Doppler frequency shift comprises an indication of the second temporal parameter for the second precoder.

30. An apparatus for wireless communication at a base station, comprising:
a processor;
memory coupled with the processor; and
instructions stored in the memory and executable by the processor to cause the apparatus to:
transmit, to a user equipment (UE), a first channel state information reference signal via a first signal path and a second channel state information reference signal via a second signal path, wherein the first channel state information reference signal and the second channel state information reference signal are each spatially precoded based at least in part on a prior communication with the UE;
receive, from the UE and based at least in part on transmitting the first channel state information reference signal and the second channel state information reference signal, signaling indicative of a first Doppler frequency shift and a second Doppler frequency shift, the first Doppler frequency shift based at least in part on an average of a first plurality of Doppler frequency shifts associated with the first channel state information reference signal and the second Doppler frequency shift based at least in part on an average of a second plurality of Doppler frequency shifts associated with the second channel state information reference signal; and
transmit, to the UE, a downlink signal communicated via the first signal path using first temporal and spatial precoding and communicated via the second signal path using second temporal and spatial precoding, the first temporal and spatial precoding and the second temporal and spatial precoding determined based at least in part on the signaling indicative of the first Doppler frequency shift and the second Doppler frequency shift.
